(19) United States
(12) Patent Application Publication
(10) Pub. No.: US 2024/0401967 A1
(43) Pub. Date: Dec. 5, 2024

(54) LOW-POWER PEDESTRIAN ROUTE RECONSTRUCTION

(71) Applicant: Apple Inc., Cupertino, CA (US)

(72) Inventors: Kenneth M. Pesyna, JR., San Jose, CA (US); Aditya Marawar, San Jose, CA (US); Christina Selle, Los Altos, CA (US); Isaac T. Miller, Half Moon Bay, CA (US); Saurabh Godha, Santa Clara, CA (US)

(73) Assignee: Apple Inc., Cupertino, CA (US)

(21) Appl. No.: 18/680,877

(22) Filed: May 31, 2024

Related U.S. Application Data
(60) Provisional application No. 63/470,723, filed on Jun. 2, 2023.
(60) Provisional application No. 63/580,909, filed on Sep. 6, 2023.

(51) Int. Cl. G01C 21/36

(52) U.S. Cl. CPC G01C 21/3676

(57) ABSTRACT

Techniques are described herein for low-power pedestrian route reconstruction. A method can include accessing location data comprising a set of location points collected by a user device during a workout and defining an initial route. The method can further include accessing map data comprising a plurality of paths within a geographic region. The method can further include, for a plurality of location point pairs of the set of location points, determining a route segment between the pair of location points that follows a path segment of the plurality of paths. The method can further include combining route segments for each location point pair of the plurality of location point pairs to define a reconstructed route that begins with a first location route pair based on an initial location point and ends with a second location route pair based on a final location point.

### CROSS-REFERENCE TO RELATED APPLICATIONS

This application claims the benefit of and priority to U.S. Provisional Application No. 63/470,723, filed on Jun. 2, 2023, and U.S. Provisional Application No. 63/580,909, filed on Sep. 6, 2023. This application is related to U.S. application Ser. No. ______ (Attorney Docket No. 090911-P62333US1-1392563), titled “Route Reconstruction Using Sparse Data Set,” filed on May 31, 2024. Each of these is incorporated by reference in its entirety for all purposes.

### BACKGROUND

Portable user devices (e.g., smartwatches, smartphones, tablets, etc.) may include a location services system for collecting location data of the user device. This location data may be useful to a user for recording outdoor workouts (e.g., walks, runs, hikes, etc.). Use of location services may be battery intensive.

### BRIEF DESCRIPTION OF THE DRAWINGS

FIG. 1 is an illustration of an example block diagram and example flowchart showing a process for reconstructed a route using sparse location data, according to one or more embodiments.

FIG. 2 illustrates an example graphical depiction of an aspect of techniques for route reconstruction using sparse location data, according to one or more embodiments.

FIG. 3 is an illustration of an example graphical depiction of an aspect of techniques for route reconstruction using sparse location data, according to one or more embodiments.

FIG. 4 is an illustration of an example graphical depiction of an aspect of techniques for route reconstruction using sparse location data, according to at least one example.

FIG. 5 is an illustration of an example graphical depiction of an aspect of techniques for route reconstruction using sparse location data, according to at least one example.

FIG. 6 is an illustration of a diagram graphically depicting an aspect of techniques for route reconstruction using sparse location data, according to at least one example.

FIG. 7 is an illustration for example data collection during various stages of a workout, according to one or more embodiments.

FIG. 8 is an illustration of an example system for reconstructing a route, according to one or more embodiments.

FIG. 9 is an illustration of a process for route reconstruction, according to one or more embodiments.

FIG. 10 is an illustration of intermittent trajectory data and odometry data aligned on map data, according to one or more embodiments.

FIG. 11 is an illustration of intermittent trajectory data and odometry data aligned with a coordinate system, according to one or more embodiments.

FIG. 12 is an illustration of intermittent trajectory data and odometry data aligned with a map data, according to one or more embodiments.

FIG. 13 is an illustration of reconstructed route with smooth corners, according to one or more embodiments.

FIG. 14 illustrates a flowchart showing an example process for implementing techniques relating to route reconstruction using sparse location data, according to at least one example.

FIG. 15 illustrates a flowchart showing an example process for implementing techniques relating to route reconstruction using sparse location data, according to at least one example.

FIG. 16 is an example application process, according to one or more embodiments.

FIG. 17 is an example application process, according to one or more embodiments.

FIG. 18 is an example user device, according to one or more embodiments.

FIG. 19 is an example computing system, according to one or more embodiments.

FIG. 20 is an example signaling diagram for communicating with an application programing interface, according to one or more embodiments.

FIG. 21 is an example signaling diagram for communicating with an application programing interface, according to one or more embodiments.

FIG. 22 depicts an example schematic diagram of a wearable electronic device, according to one or more embodiments.

FIG. 23 depicts a user wearing a first electronic device with a second electronic device 2404 in his pocket, according to one or more embodiments.

FIG. 24 illustrates an example architecture or environment configured to implement techniques relating to reconstructed routes using sparse location data, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The examples described herein relate to techniques, devices, systems, computer-readable media, and the like for performing route reconstructions using location data collected in various data collection modes. For example, a portable user device such as a smartwatch may include a location services system capable of recording a geolocation of the user device. The portable user device may operate in a plurality of modes as it relates to location collection. For example, in a first operating mode (e.g., a typical workout mode), the user device may collect location data at a first frequency (e.g., around 1 Hz). In this first operating mode, the user device may also utilize a dynamic data collection mode that includes the user device collecting location data at various frequencies during an activity (e.g., at a lower frequency when a user begins an activity and at a higher frequency once the user device prompts the user to begin recording a workout for the activity). In a second operating mode (e.g., a low-power or sparse data collecting mode), the user device may collect location data at a lower frequency than the first mode (e.g., between 0.02 and 0.01 Hz). In a third operating mode (e.g., a non-workout typical mode), the user device may collect location data when requested by a different service or application of the user device. In some examples, operating in the first operation mode may result in dense location data, but at the cost of increased battery drain. Operating in the second operating mode may result in sparse location data, but with the benefit of less battery drain, as compared to the first operating mode.

Turning now to a first particular example, a user can have a user device during a workout (e.g., along a walk, hike, or the like). The user can use the user device to record the workout while in a battery-saver mode. The user device can collect location data at a lower than normal rate while the user is in the workout. The user device can further collect odometry data while the user is in the workout. Once the workout is complete, the user device can use the location data and the odometry along with map data (e.g., from a map application on the user device) to reconstruct the route traveled by the user. The reconstructed route can correspond to one or more roads indicated by the map data.

The examples described herein address a number of technical problems and provide for a number of technical improvements. In some examples, these improvements additionally improve the functioning of various components of a system or device in which the techniques are implemented. The techniques described herein provide for route reconstruction using sparse location data in a manner that conserves battery life and minimizes network traffic, as compared to conventional systems. For example, rather than collecting location data at a higher frequency, the location data is collected at a much lower frequency, and then, as part of a post-processing operation, the location data points are “stitched” together and matched to underlying map data. Operating location services less frequently may dramatically conserve battery life, as compared to a more frequent collection. Moreover, by post-processing using map data that has been cached previously cached on the user device, the user device does not have to download additional maps data. Any additional processing (and battery usage) required to match the location data to the maps data is negligible when compared to the battery savings from less frequent location data collection.

A user device may include an option to select between different operating modes. For example, U.S. application Ser. No. 18/304,104 filed Apr. 20, 2023, which is incorporated herein by reference in its entirety, describes an approach for providing location services with positioning information while preserving the life of a battery. These approaches may be used in connection with the route reconstruction techniques described herein to pick which operating mode is to be used under which circumstances. In some examples, other approaches for route reconstruction may be implemented in connection with the techniques described herein. For example, U.S. Application Ser. No. 63/470,723 filed Jun. 2, 2023, which is incorporated herein by reference in its entirety, describes approaches for route reconstruction based on sparse data.

Turning now to a second particular example, a user device can automatically start recording location data of the user device while simultaneously collecting odometry data. For example, the user device can detect that the user is beginning to go on a walk. However, the user may not have begun to record the walk on the user device. Therefore, even though the user has not started recording the walk, the user device is still collecting location data and odometry data. Therefore, once the user does start recording the walk, the initial port of the walk, before the user started recording can be included in the total length of the walk.

The examples described herein address a number of technical problems and provide for a number of technical improvements. In some examples, these improvements additionally improve the functioning of various components of a system or device in which the techniques are implemented. The techniques described herein permit the use of sparse location data and odometry data to be used accurately reconstruct a portion of a route prior to the user recording the route.

The techniques described herein further include the collection of sparse location data, which provides battery savings for the user device. Therefore, techniques herein permit location data to be collected in a battery saving manner, and that location data can be used to accurately reconstruct a route.

The techniques described herein further provide for route reconstruction using data collected by a user device via a dynamic data collection mode in a first operating mode. The user device can detect that the user device is being placed into motion based on odometry data (e.g., velocity data, acceleration data, directional data, and the like). For example, the user device may detect that a user is beginning an outdoor walk. Based on detecting the motion, the user device can begin to collect sparse location data (e.g., at a generally low frequency) and odometry data. The user device may record a beginning location of this motion, which is beginning to form a route. As the user device continues to move, the user device continues to collect the sparse location data and the odometry data, the user device can provide the user with an alert that includes an option to record a workout (e.g., an outdoor walk) relating to the motion. Based on this alert and/or the user accepting the option to record the workout, the user device can begin to collect more dense location data (e.g., at a generally high frequency) along the route at least until the workout ends. At the ending location, the user device may record an ending location for the route. The sparse location data and the odometry data for the first portion of the route can be combined with the dense location data and the remaining odometry data for the remaining portion of the route to define the route from the beginning location to the ending location. This data may be compared to map data from a map application to generate a reconstructed route.

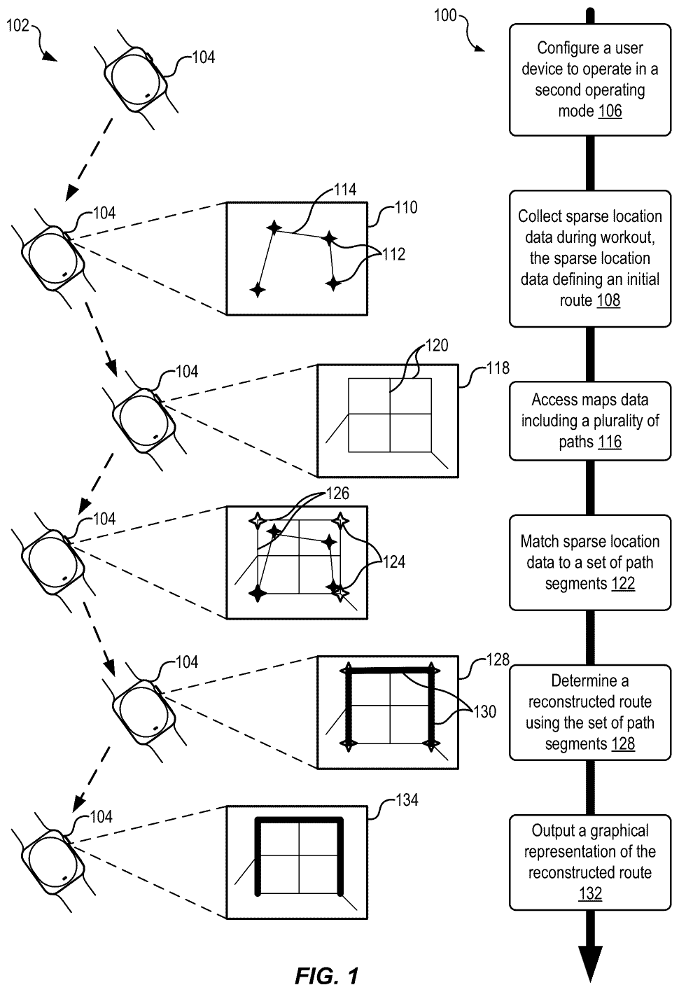

FIGS. 1, 14, and 15 illustrate example flow diagrams showing processes 100, 1400, and 1500700, according to at least a few examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

Turning now to the figures, FIG. 1 illustrates an example block diagram 102 and an example flowchart showing a process 100 for reconstructing a route using sparse location data, according to at least one example. The diagram 102 includes a user device 104 (e.g., portable user device such as a smartwatch, smartphone, tablet, laptop, etc.). In particular, the diagram 102, which is indicative of a computer architecture that may be used to implement the techniques described herein, includes the user device 104. The user device 104 may also include storage media for storing computer-executable instructions (e.g., that make up an application) and other data such as described herein (e.g., location data, maps data, etc.). The user devices 104 may be operated by user.

The process 100 begins at block 106 by the user device 104 configuring the user device 104 to operate in a second operating mode (e.g., a sparse data collecting mode). In some embodiments, the user device 104 can include an application (e.g., a workout application) that can be used to track fitness activities and provide real-time metrics and feedback to a user. For example, the user device 104 can be a smartwatch and the user may select an application icon to begin a workout. The user may also use the application to enable the various operating modes described herein. Block 106 may be performed by a user configuring a setting of the user device 104, based on context, or in some other automated manner. For example, as described in U.S. application Ser. No. 18/304,104 filed Apr. 20, 2023, the mode may be selected based on contextual information. The selected operating mode can be a sparse data collecting mode. For example, the selected operating mode can have a battery saver component and collect data at lesser rate than a data collection mode that does not include a battery saver component. For example, the selected operating mode can collect data at a rate of 0.5 Hz or less, whereas another operating mode can collect data at a rate of greater than 0.5 Hz. The collected data can be location data in a time series format as to the location of the user device 104. For example, the application can access a location service (e.g., global navigation satellite system (GNSS) and collect the location data, or the application can access a second application (e.g., a web browser, a streaming service, or other appropriate application), where the second application collects location data. In some embodiments, the application performs a combination of accessing location data from a location service and from one or more other applications.

At block 108, the process 100 includes the user device 104 collecting sparse location data 110 during a workout. The workout may be initiated using a workout application of the user device 104 or some other connected device. When in the workout, the user device 104 may be configured to track location data of the user device, which, when in the second location data collection mode, may include sparse location data 110. In some examples, sparse location data may include data collected at 0.5 Hz or less. The sparse location data 110 may include location points 112. Each location point 112 may correspond to a recorded location having at least an X and a Y coordinate (e.g., a latitude and longitude). Each location point 112 can further be in a time-series format, such that a time of collecting the location point 112 is indicated in the sparse location data. The location points 112 may be “connected” by an initial route line 114. The initial route line 114 may represent what an initial route would look like if connected directly between subsequent location points 112. It should be appreciated that the location points 112 may not be completely accurate at to the location of the user device 104 at a particular point in time. There can be various reasons as to why location data is not accurate. For example, taller structures surrounding the user device 104 may disrupt location signal, satellite positioning, or other factors.

At block 116, the process 100 includes the user device 104 accessing maps data 118 including a plurality of paths 120. The plurality of paths may include, in addition to roads, walking trails, bike paths, hiking trails, sidewalks, and the like. The maps data 118 may have been previously downloaded and cached to the user device 104. The maps data 118 can be accessed from a map application on the user device 104. For example, an application (e.g., a workout application) can make an API call to request the map data 118 from the map application. The map application can respond to the request by providing the requested map data 118. The application can obtain the map data 118 via the API. In some examples, the maps data 118 may be downloaded and cached on the user device 104 according to techniques described in U.S. Application Ser. No. 63/470,794 filed Jun. 2, 2023, which is incorporated herein by reference in its entirety. The plurality of paths 120 may correspond to roads, paths, trails, and the like, which are represented by the maps data 118. In some examples, the plurality of paths 120 may correspond to a road network. Each segment of the road network may correspond to a path of the plurality of paths 120. The maps data 118 may also include metadata to store properties of each path. For example, the metadata may indicate a direction of travel, a road type, whether the road permits pedestrian traffic, and any other suitable property relating to the path.

At block 122, the process 100 includes the user device 104 matching sparse location data (e.g., the location data 110) to a set of path segments 126 (e.g., some of the paths 120). Part of this process may include defining a matched set of location points 124, which correspond to the location points 112 and are matched to the path segments 126 (e.g., the parts of the paths 120 that connect the matched location points 124). Any suitable pathfinding algorithm may be used to match the sparse location data to the set of patch segments. For example, A* search algorithms may be used to identify a shortest path between adjacent location points 112 with the constraint that the path follow along a path 120. As is described below, in some instances, the process 100 may include selecting a path from a set of candidate paths from one location point to another location point. As discussed below, the process 100 can include using different techniques (e.g., using motion data, considering more than two adjacent location point, or the like) to select a path from a set of candidate paths.

At block 128, the process 100 includes the user device determining a reconstructed route 130 using the set of path segments 126. The reconstructed route 130 may include an addition of the set of path segments 126 and a graphical representation of those segments. The reconstructed route 130 represents a prediction of the actual path the user device 104 followed when the sparse location data 110 was originally captured. The reconstructed route 130 may also be used to compute an accurate odometer reading, e.g., a distance for the route, as compared to the initial route. Information about the reconstructed route 130, including elevation changes, distances, and the like may be presented on a user interface of the user device 104.

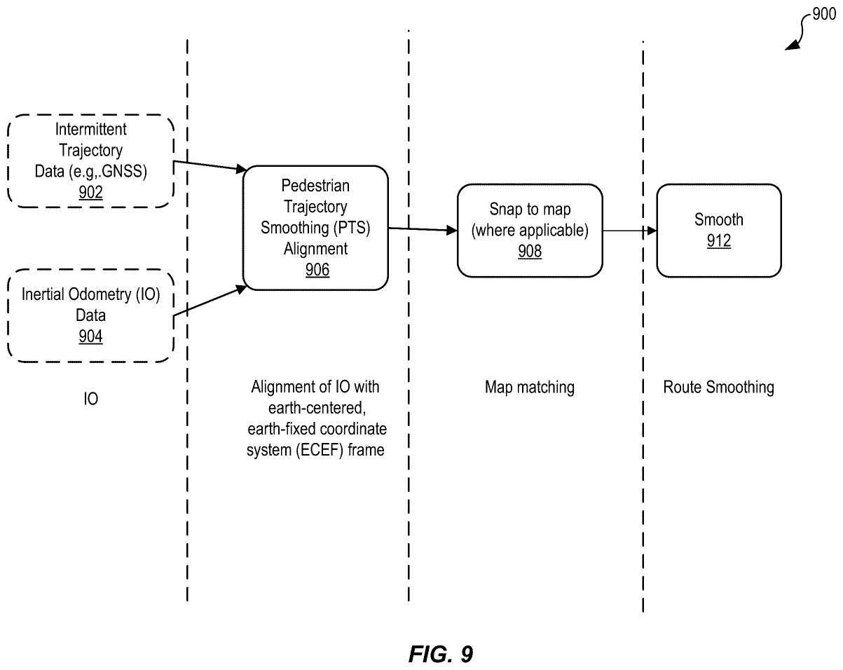

At block 132, the process 100 includes the user device outputting a graphical representation 134 of the reconstructed route. This may be presented at the conclusion of the workout or at any other suitable time and in any other suitable manner. In some examples, the accuracy of the reconstructed route with respect to the underlying map data may be improved using the techniques described herein. For example, the techniques described with respect to FIGS. 9-13 may be applicable to improving the reconstructed route.

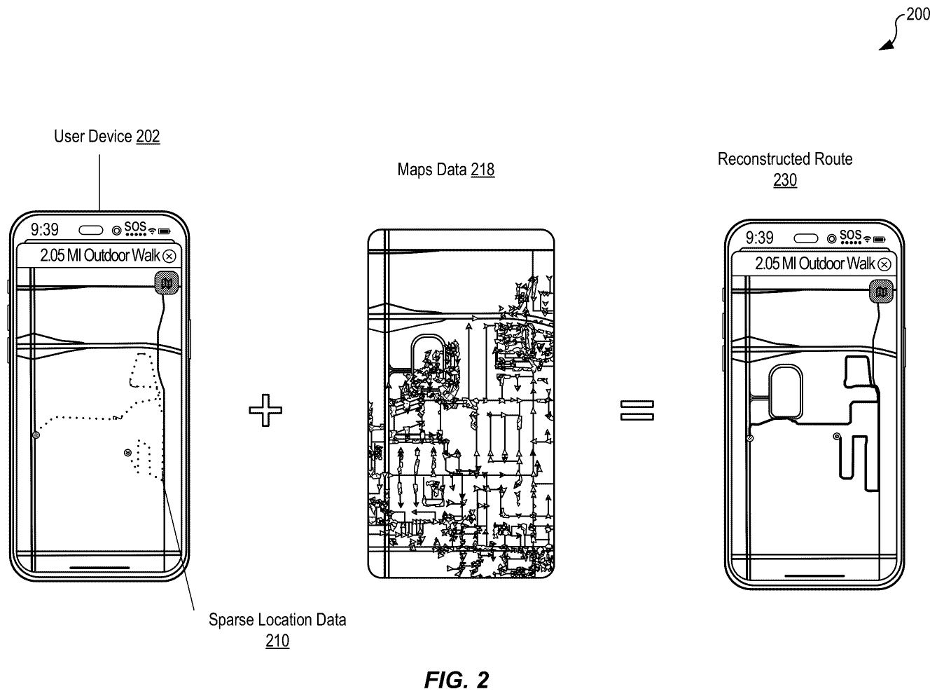

FIG. 2 illustrates a diagram 200 graphically depicting an aspect of techniques for route reconstruction using sparse location data, according to at least one example. The diagram 200 includes a visual representation of sparse location data 210 (e.g., the sparse location data 110) depicted on a display of a user device 202 (e.g., a smartphone), along with an underlying map view. A solid line depicts the presence of a location point and a dashed line indicates a “connected” initial route, which represents more or less a connection between location points without regard to the underlying map view. The diagram 200 also includes maps data 218 (e.g., the maps data 118). The maps data 218 may represent roadways or other paths that users moved on. In some examples, the maps data 218 may be processed by a service provider as part of generating the maps data. The techniques described herein, as shown in FIG. 2, may include using the sparse location data 210 and the maps data 218 to end up with a reconstructed route 230. As illustrated, the reconstructed route 230 has taken the sparse data 204 and aligned them with roads/walkways/sidewalks/etc. from the maps data 218.

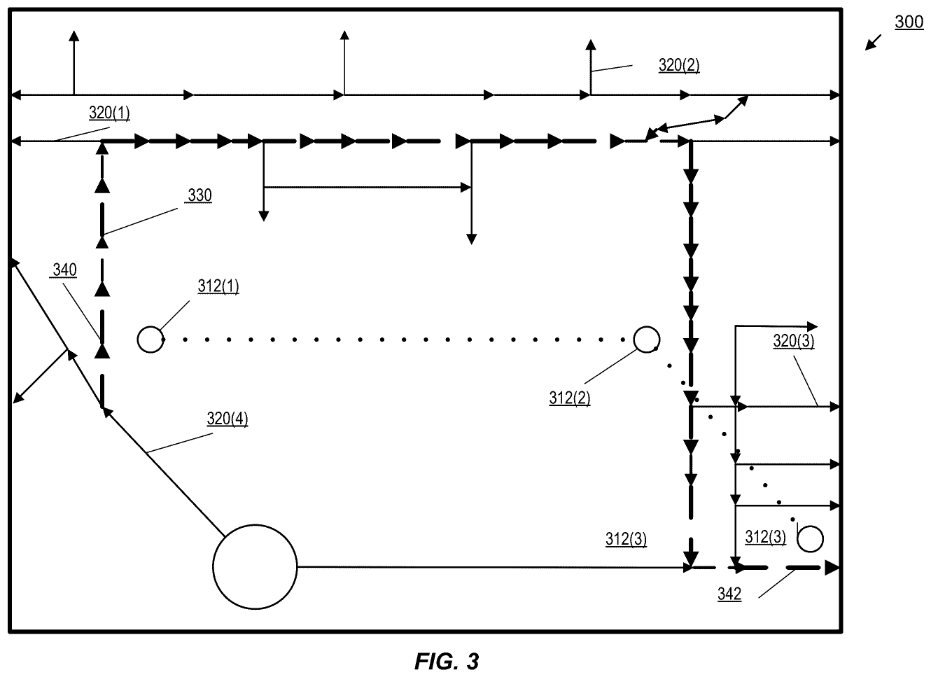

FIG. 3 illustrates a diagram 300 graphically depicting an aspect of example techniques for route reconstruction using sparse location data, according to at least one example. The diagram 300 includes sparse location points 312. The sparse location points 312 may be connected by an initial route line 314 (represented by a dotted line). The initial route line 314 may represent what a route would look like, if not reconstructed using the techniques described herein. The diagram 300 also includes a plurality of paths 320. The paths 320 are shown as vectors representing an anticipated direction of vehicular travel. Though, the directionality may not be considered when reconstructing routes for hiking, walking, etc. The certain segments (e.g., 320(1), 320(2), 320(3), 320(4) of the paths 320 correspond to potential segments that a pathfinding algorithm may consider when computing the segments for a reconstructed route 330. The reconstructed route 330 may be represented by the vectors that have been bolded and include dashed lines and begin near the sparse location point 312(1) and end near the sparse location point 312(3). Each arrow in the reconstructed route 330 corresponds to an estimated location point along one of the paths 320 at a predetermined sampling rate (e.g., 1 Hz). As illustrated, the vectors of the reconstructed route are not a uniform length, as a user device (e.g., user device 104) collecting the spare location data may not be moving at a unform velocity along the route. For example, the reconstructed route 330 may be reconstructed as if it the location services were used to take a location data point at 1 Hz while the user device moved along the paths 320. In some examples, the techniques described herein may pick a beginning point 340 for the reconstructed route 330 as a point on a path 320 that is nearest to the first sparse location point 312(1). Similarly, the techniques described herein may pick an ending point 343 for the reconstructed route 330 as a point on a path 320 that is nearest the last sparse location point 312(3). To determine the portion of the reconstructed route 330 between a first pair of sparse location points 312(1), 312(2), the techniques described herein may snap the sparse location points 312 to the nearest segments and then compute a shortest distance between the two road segments. For example, the user device can use a pathfinding algorithm to determine a shortest distance between the segments. The pathfinding algorithm can be constrained to determine the shortest distance based on traversing segments of the plurality of paths 320. Therefore, in some embodiments, the shortest distance does not include a portion that is off of the segments of the plurality of paths 320. This process can be repeated for the next pair of sparse location points 312(2), 312(3) until all pairs of location points have been evaluated and matched to the paths 320. Once all of the path segments 320 have been identified, they path segments may be added together to generate the reconstructed route 330.

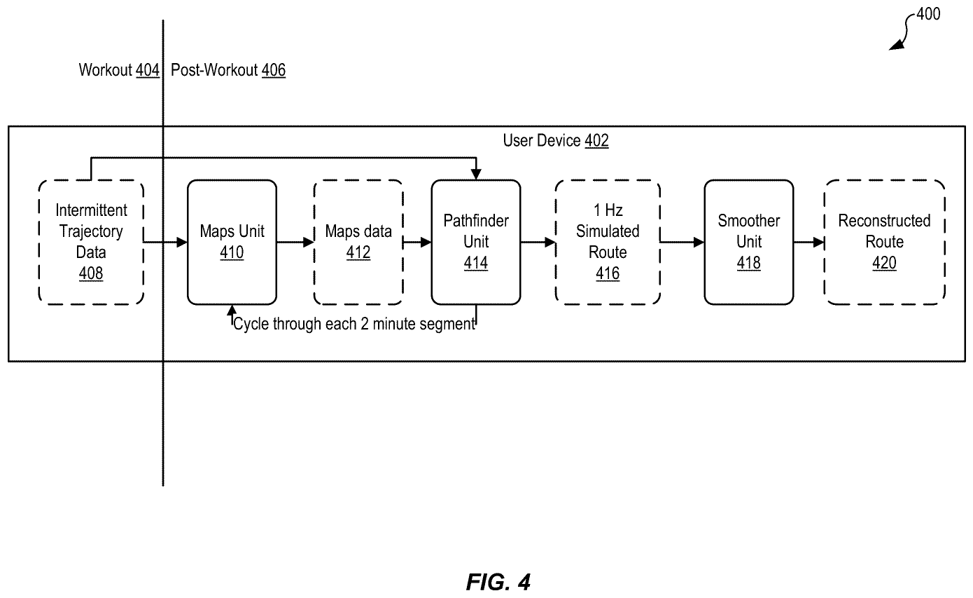

FIG. 4 illustrates a diagram 400 graphically depicting an aspect of example techniques for route reconstruction using sparse location data, according to at least one example. The diagram 400 depicts that a user device 402(e.g., user device 104) can in real-time collect “intermittent trajectory” data. This may include collection of sparse location data (e.g., sparse location points 312) during a period, in which the user device is in a workout mode (e.g., workout 404). After a workout has concluded (e.g., post workout 406), the techniques herein may include the operations of buffering map data, using a pathfinding algorithm (e.g., A* search algorithm) for determining a shortest path, propagating 1 Hz locations points, and applying a smoothing operation on the propagated points.

The intermittent trajectory data 408 can be transmitted to a maps unit 410, which can include a map application executing on the user device 402. The user device 402 can use location information (e.g., latitudinal and longitudinal information from sparse location points) to identity a plurality of paths whose location corresponds to the location of the intermittent trajectory data 408. For example, referring back to FIG. 2, it is illustrated that the sparse location data 210 corresponds to a same location as the maps data 218.

A pathfinder unit 414 can access the intermittent trajectory data 408 and the maps data 414 to determine a path of segments between the sparse location points of the intermitted trajectory data 408. The pathfinder unit 414 can be configured to use a pathfinding algorithm (A* search algorithm, Dijkstra's algorithm, Greed Best-First search algorithm). The pathfinder unit 414 can associate (e.g., snap) sparse location points with segments (e.g., 320(1), 320(2), 320(3), 320(4). The segments may be associated with the sparse location points may not be contiguous. Therefore, the pathfinder unit 414 may need to determine one or more intermediate segments to connect the segments may be associated with the sparse location points. As is common in a real world situation, there is more than one set of segments (road segments, path segments, trail segments) that can be traversed to get from one point to another point. Furthermore, in the real world, each of the segments may have their own qualities. For example, some segments can be quicker than other segments, some segments may be more scenic that other segments, and some segments may have other qualities. For example, on set of segments may traverse a bike path on a bridge over a city with no traffic lights, but a higher average speed. A parallel set of road segments may traverse sidewalks through the same city. It may be possible to move from one segment associated with a location point (e.g., location point 312(1)) to another segment associated with another location point (e.g., location point 312(2)). The pathfinder unit 414 can analyze each of these sets of segments and determine whether the user device moves across which set of segments (e.g., bike path segments or sidewalk segments). The pathfinder unit 414 can use various constraints (e.g., shortest distance, shortest time, or like) to determine which set of segments to use to determine a reconstructed route (e.g., reconstructed route 330).

The pathfinder unit 414 can further generate a 1 Hz simulated route 416, which includes a density of location points as if the user device had collected intermittent trajectory data 408 at a rate of 1 Hz. Each of segments obtained from the maps data 412 can have been defined by location points that have a density as if collected at 1 Hz. These location data points can be as stored on a maps application, and the user device may not need to perform more than selecting a set of segments. Therefore, the user device may not need to generate locations points in order to reach the 1 Hz density.

A smoother unit 418 can access the 1 Hz simulated route 416. A conventional map application can display a road network and a directional route for a vehicle to follow. However, the conventional map application displays angled corners. For example, if a vehicle is at a cross-section and is to make a right turn or a left turn, the right turn and the left turn are displayed as perfect 90 degree turns. A human that is viewing a visual representation of a reconstructed route that they have traveled, perhaps a hiking trial, may recognize that they do not move in precise angles. Rather a human's movements may be more rounded while making a turn. Therefore, the smoother unit 418 can round out angled corners. For example, the smoother unit 418 can identify two segments that are connected at vertex that forms an angle. The smoother unit 418 can then determine a radius for a rounded corner. Based on the radius, the smoother unit 214 can remove the vertex and generate a rounded corner connecting the two segments. A visual representation of the rounded corner can create the impression that a user moved along the reconstructed route in a more human-like (e.g., walking in a curved rather than angled manner). The smoother unit 418 can generate rounded corners for each identified angled vertex.

The result of the post-workout operations may include a reconstructed trajectory 410 (e.g., a reconstructed route 330). In some instances, the maps unit 410 can repeatedly generate maps data 412 based on the pathfinder unit 414 transmitting 1 Hz simulated route 416 to the maps unit 410. The 1 Hz simulated route 416 may be repeated for each segment of data collected over a time period (e.g., 2 minutes). In some examples, if the data collection mode is set to sparse collection, a single location point may be collected each 2 minutes.

In some instances, the reconstructed route 420 can be accessed by a health application or other suitable workout application on the user device. A user can activate the health application on their user device and a visual representation of the reconstructed route 420 can be displayed on the user device.

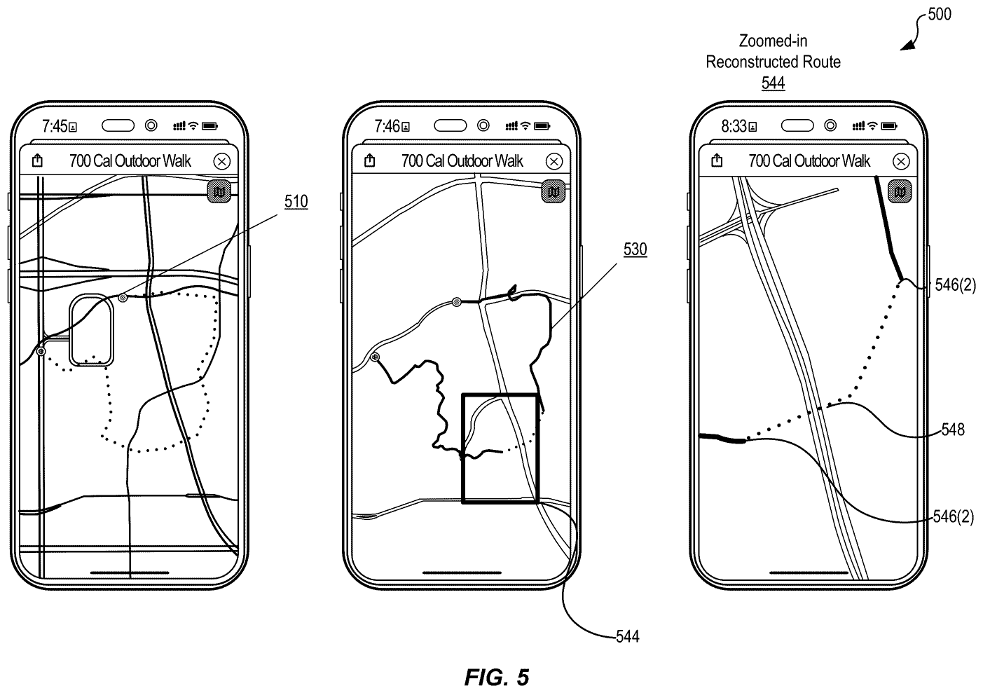

FIG. 5 illustrates a diagram 500 graphically depicting an aspect of techniques for route reconstruction using sparse location data, according to at least one example. The diagram 500 includes sparse location data 510 depicted on a display of a user device (e.g., a smartphone), along with an underlying map view. A solid line (or dot) depicts the presence of a location point and a dashed line indicates a “connected” initial route, which represents more or less a connection between location points without regard to the underlying map view. The diagram 500 also illustrates a reconstructed route 530. The functionality of visual representation of the reconstructed route 530 can include a zoom feature. For example, the area encompassed by the box icon 544 can be zoom out to provide a more detailed view of the area. As shown in the zoomed in view 544, the reconstructed route 530 includes a first transition point 546(1), a second transition point 546(2), and an undefined route portion 548. It is also shown that the transition points are defined by rounded corners as described with reference to FIG. 4. The undefined route portion 548 may represent that the techniques described herein were unable to identify a path segment from maps data for this section of the route 530. This may be because the maps data does not exist and/or because the user device moved through areas where there are not roads or paths. For example, the user carrying the user device in the diagram 500 may have gone “off path” between the first transition point 546(1) and the second transition point 546(2). The system may not have sufficient confidence that the user device traveled a different route, which may not represent a shortest route. The user device may use other data to approximate the undefined route portion 548, which may include, for example, pedometer data from the user device. The pedometer data can include, for example, step count, distance traveled, active time and the like. The pedometer data can be collected by one or more sensors (e.g., accelerometer, gyroscope) of the user device. The pedometer data may be used to approximate the distance traveled between the two points 546(1), 546(2) in order to increase system confidence that the undefined route 548 is correct. That being said, the system may present to the user that the undefined route portions 548 using a different line type (e.g., a different visual representation) in order to call attention to the fact that the user device could not identify a route between the points 546(1), 546(2) with sufficient confidence.

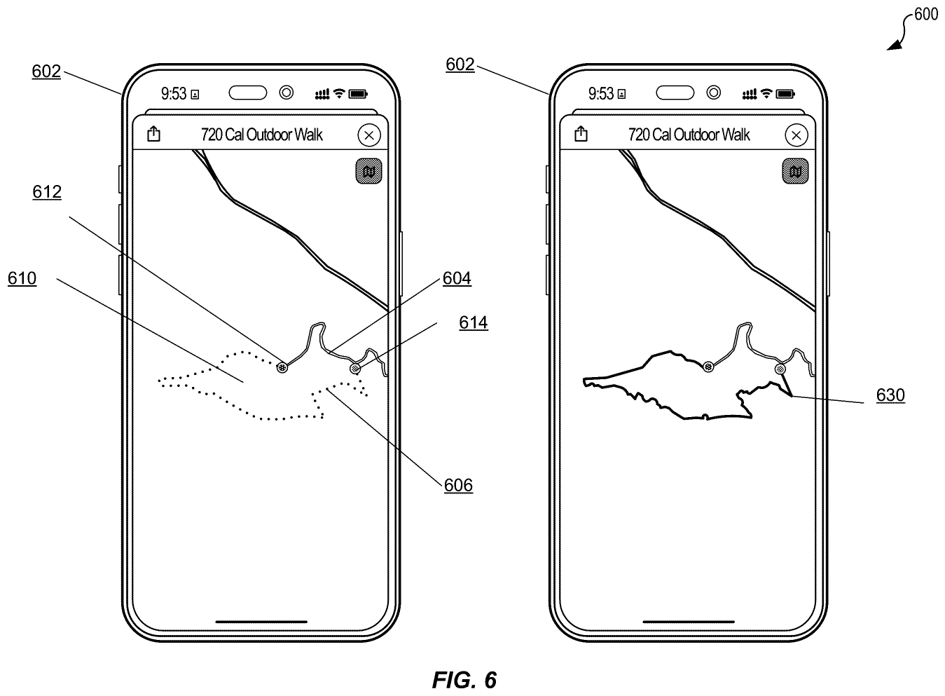

FIG. 6 illustrates a diagram 600 graphically depicting an aspect of techniques for route reconstruction using sparse location data, according to at least one example. The diagram 600 illustrates how the techniques described herein may be applied to hiking trails. The diagram 600 includes sparse location data 610 (e.g., the sparse location data 110) depicted on a display of a user device 602(e.g., a smartphone), along with an underlying map view. A solid line 604 depicts the presence of a location point and a dashed line 606 indicates a “connected” initial route, which represents more or less a connection between location points (e.g., first location point 612 and second location point 614) without regard to the underlying map view. It should be appreciated that in some instances, the maps data (e.g., maps data 412) corresponds to hiking trails and not necessarily paths that can be traveling along by a motor vehicle. The techniques described herein can be used to reconstruct a route for various types of paths, such as paved or unpaved paths for use by vehicles, bicycles, foot traffic, or a combination thereof.

The diagram 600 also depicts a reconstructed route 630 on the user device 602. The reconstructed route 630 has taken the sparse data 610 and aligned them with the paths depicted in the map view. The techniques described herein can be used to collect intermittent trajectory data (e.g., intermittent trajectory data 408) and access map data (e.g., map data 412) from a maps unit (e.g., maps unit 410). The maps unit can provide maps data that corresponds to one or more location points of the intermittent trajectory data. As illustrated in FIG. 6, the maps data can include hiking trail data. A pathfinder unit (e.g., pathfinder unit 414) can determine a set of segments that connect the location points of the intermitted trajectory data to generate a 1 Hz simulated route (e.g., 1 Hz simulated route 416). A smoother unit (e.g., smoother unit 418) can replace any angled corners with rounded out corners. In some instance, the rounded-out corners may not be readily apparent from a user device display. For example, in a zoomed-out view, the corner may still appear to be angular. However, if a user zooms in, as described with respect to FIG. 6, the rounded corners may be more readily apparent.

The description above relates to route reconstruction while the user device is in a second data operating mode that includes a sparse data collection mode. The user may set the user device in a low-power mode, such that the user device is collecting sparse location data (e.g., intermittent trajectory data 408), as opposed to data collection in a non-battery saver power mode (e.g., collecting location data at a rate of 1 Hz or greater). In a real-life scenario, a user may begin physical exercise (e.g., starting to go on a hike) without initially setting the user device to record a workout. The user may at some point during the physical exercise, begin recording a workout, however, it still may be valuable for the user to have a reconstructed route for the time period between starting to exert physical effort and beginning the workout.

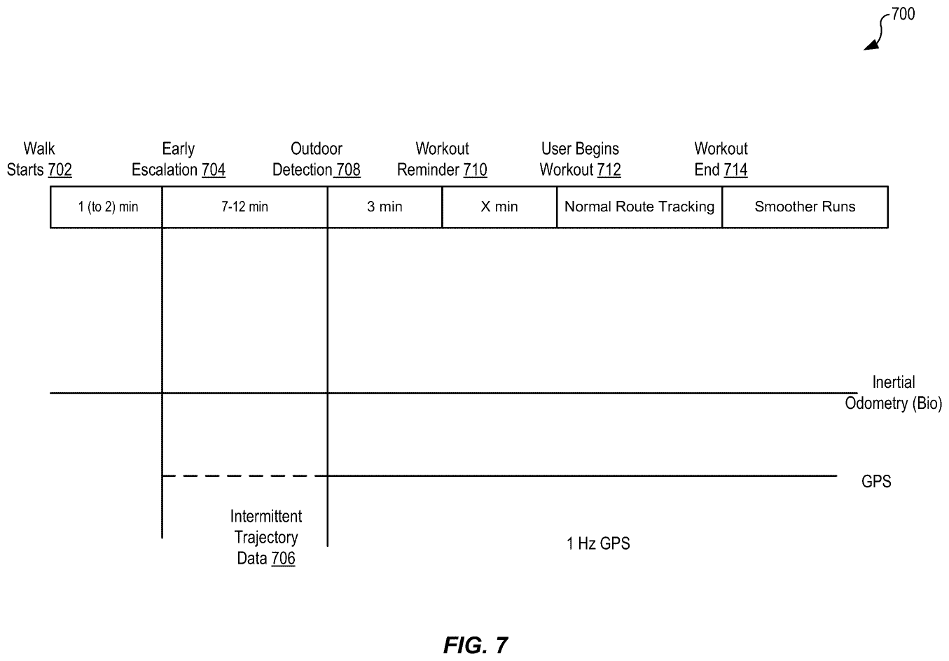

FIG. 7 is an illustration 700 of example data collection during various stages of a workout, according to one or more embodiments. The illustration 700 corresponds to a user device operating in a first operation mode and collecting data using a dynamic data collection mode, as described herein.

At 702, a user can start walking while using a user device (e.g., wearing a wearable user device as shown as the user device 104). The user device may include an application that includes functionality to record a workout. However, at 702, the user has not requested that the application record the workout. During this time, the user device can use one or more sensors (e.g., a gyroscope, an accelerometer, an inertial motion unit (IMU), and other odometry-related sensors) to collect odometry data. The odometry data can include motion-related data, such as velocity, direction, acceleration, and the like. Odometry data collection can consume less energy than location sensing. Therefore, the user device can continuously collect odometry data without the energy consumption concerns for continuously collecting location data. As illustrated, the user device can collect odometry data without also collecting location data for a first period (e.g., approximately 1 to 2 minutes). It should be appreciated that the first period, i.e., between 702 and 704, may be longer or shorter than what is illustrated.

At early escalation 704, the user device can then begin to collect intermittent trajectory data 706 during a second period beginning with early escalation 704 and ending with outdoor detection 708. It should be appreciated that during this time, the user may still have not begun recording a workout mode on the user device. Rather the user device, based on the odometry data may have determined that the user is actively moving and begun to start collecting the intermittent trajectory data. The intermittent trajectory data 706 may be similar to the intermittent trajectory data 408 of FIG. 4, but collected before the user device is recording a workout, and not necessarily while the user device is in a low power-mode (e.g., the second operating mode). Thus, while the second operating mode includes the user device collecting sparse location data during the entirety of the workout, the mode described in FIG. 7, includes dynamic data collection. The user device may collect the intermittent trajectory data 706 during the period of early escalation 704 for approximately 7-12 minutes. It should be appreciated that the second period, i.e., between 704 and 708 may be longer or shorter than what is illustrated. During the period of early escalation 704, the user device may continue to collect the odometry data at the same rate as the approximately one to two minutes before the early escalation 704.

At the close of the period of early escalation 704, the user device can engage in a period of outdoor detection 708. During this third period, the user device can begin to collect location data at a higher rate than the collection rate for the intermittent trajectory data 706. For example, the user device can collect location data at a rate of 1 Hz. The user device can engage in the period of outdoor detection, based on, for example, detecting motion data for the period of early escalation 704. During the period of early escalation 704, the user device continue to collect the odometry data at the same rate as during the period of early escalation 704. It should be appreciated that the third period, i.e., between 708 and 710 may be longer or shorter than what is illustrated.

After approximately three minutes, the user device can provide a workout reminder 710. The workout reminder 710 can be provided, for example, as a prompt displayed on the user device, an audio signal projected via the user device, or some other technique for providing the workout reminder 710. The user can either accept the workout reminder 710 and enable the user device to begin a workout, or the user can ignore the workout reminder 710. If accepted, the user device will begin recording a workout and continue to collect the location data at the higher frequency.

As illustrated, after X minutes, the user begins the workout 712. during the workout, the user device can engage in normal route tracking. The normal routine tracking can include collecting odometry data and location data at 1 Hz. The user may end the workout by entering a command onto the user device. For example, the user can interact with an icon on the user device and have the user device a register a workout end 714. At the conclusion of the workout, the user device can generate a reconstructed route (e.g., reconstructed route 630).

Part of generating the reconstructed route may including smoothing the route. For example, a smoother unit (e.g., smoother unit 418) can be used to smooth out any angled corners in the reconstructed route. FIG. 7 is illustrative of a location detection feature of the embodiments herein.

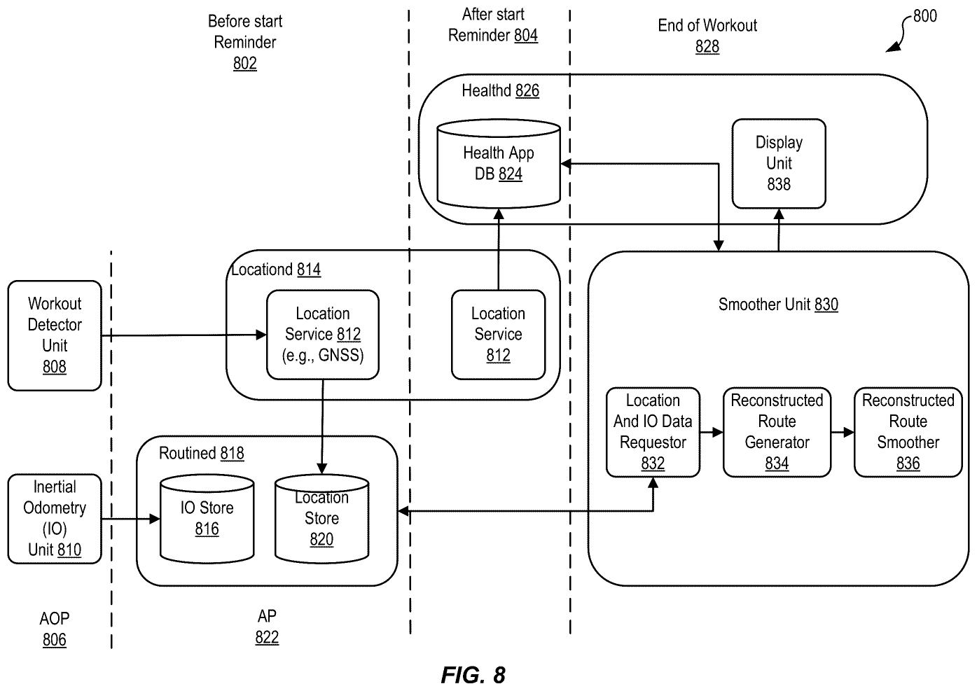

FIG. 8 is an illustration of an example system for reconstructing a route, according to one or more embodiments. FIG. 8 is illustrated to describe the user device software and hardware components that are used to reconstruct a route. FIG. 8 is further divided between before a workout reminder 802(e.g., before workout reminder 710) and after workout reminder 804 (e.g., after workout reminder 710). The processing steps for constructing a route can be performed by an always-on-processor (AOP) of the user device (e.g., user device 104). The AOP can be a processor that is configured to remain powered up when other elements of the user device are powered down. The AOP can be connected to one or more sensors, such as motion sensors for collecting location data and odometry data.

The AOP 806 can include one or more processors that are configured to execute instructions for a workout detector unit 808 and instructions for an inertial odometry (IO) unit 810. As described above, the workout detector 808 can detect that a user has started to engage in physical activity, but before the user has begun recording a workout on the user device. The workout detector unit 808 can engage with a location service 812(e.g., GNSS) to collect intermittent trajectory data (e.g., intermittent trajectory data 408) via a location daemon (locationd) 814. The user device can further include an inertial odometry unit 810 that can include sensors (e.g., gyroscope, accelerometer IMU) that can continuously collect odometry data and store the odometry data in an IO store 816 via a routine daemon (routined) 818. The location service 812 can further store location data (e.g., intermittent trajectory data) in a location store 820 via the location daemon 814 and the routine daemon 818. In some embodiments, the user device can further include an application processor (AP) 822 that can include one or more processors that are configured to execute the instructions for location daemon 814 and the routine daemon 818. The AP 822 can be different than the AOP 806 in that the AP 822 can remain in a powered down mode until prompted by the AOP 806 to execute one or both of the location daemon 814 or the routine daemon 818.

After the workout reminder 804 from the user device, the location service 812 can transmit the intermittent trajectory data to a health application database 824 via a health daemon (heatlthd) 826. It should be appreciated that after the workout reminder 804 indicates a period after the workout reminder has been sent, and not necessarily that the user has accepted the workout reminder and turned the workout mode on.

At some point, the user can indicate via the user device to stop recording a workout, such that the user device is a period of end of workout 828. The health daemon 826 can call a smoother unit 830 (e.g., smoother unit 418) to reconstruct a route. The smoother unit 830 can include a location and IO data requestor 832 configured to request, via the routine daemon 818, IO data from the IO store 816 and intermittent trajectory data from the location store 820. The user device can further include a reconstructed route generator 834. In some embodiments, the reconstructed route generator 834 can include a pathfinder unit (e.g., pathfinder unit 414). In other embodiments, the pathfinder unit can be distinct from the smoother unit 830, as illustrated in FIG. 4. As described above, the reconstructed route generator 834 can generate a reconstructed route. An example process for reconstructing a route is explained with more detail with respect to FIG. 9. The output of the reconstructed route generator 834 can be a reconstructed route with angled corners. Therefore, the smoother unit 830 can further include a reconstructed route smoother 836 configured to replace angled corners of the reconstructed route with rounded corners.

The smoother unit 830 can transmit control instructions to a display unit 838. The display unit can display the reconstructed route on a display of the user device (see, for example, the reconstructed route 630 of FIG. 6).

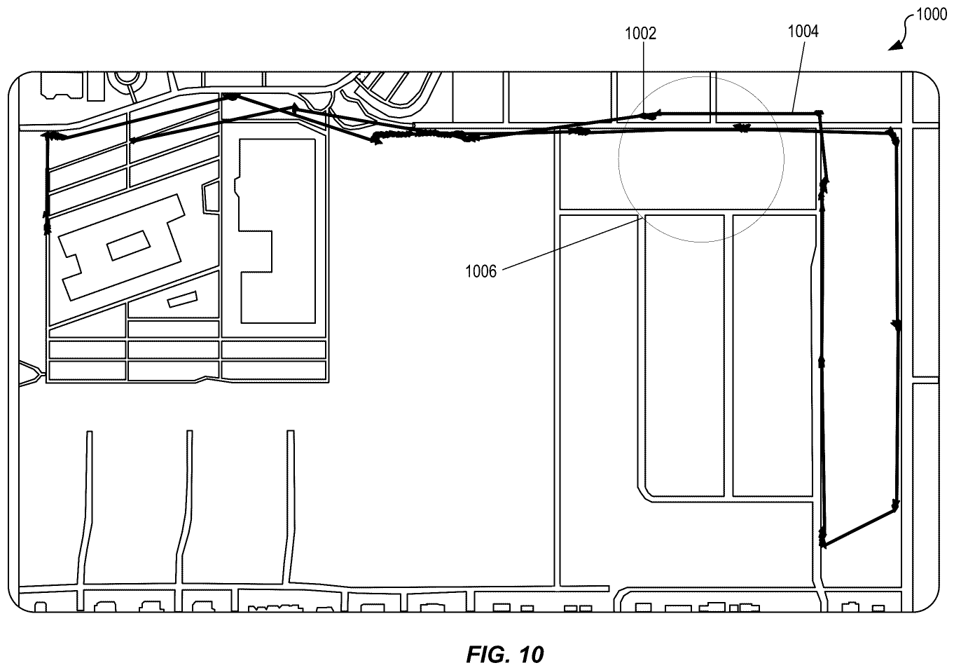

FIGS. 9-13 are provided to assist with describing a process for route reconstruction. FIG. 9 provides a textual description of the process, and FIGS. 10-13 provide illustrations of the textual steps described in FIG. 9. FIG. 9 is an illustration 900 of a process for route reconstruction, according to one or more embodiments. Intermittent trajectory data 902(e.g., intermittent trajectory data 408) and odometry data 904 (e.g., the IO data) can be processed by a user device (e.g., user device 104). In some embodiments, the intermittent trajectory data 902 and the inertial odometry data 904 can be processed using a technique for pedestrian trajectory smoothing (PTS) alignment 906. The technique for PTS alignment can be used to align the inertial odometry data 904 with a global reference frame (e.g., coordinate system) using the intermittent trajectory data 902.

FIG. 10 is an illustration 1000 of intermittent trajectory data arranged on map data, according to one or more embodiments. Referring to FIG. 10, it is illustrated that the intermittent trajectory data 902 has been arranged on map data. Various location points 1002 of the intermittent trajectory data 904 are arranged on the map data and illustrated as a bolded line. It can be seen that the bolded line does not quite follow the path network and at various instances (e.g., instance 1006 indicated by a circle), the line runs off of the paths. It can be seen from FIG. 10 that prior to snapping the location points to segments, how the route can veer off into untraversable spots. For example, the route can veer off through a building wall or over a lake.

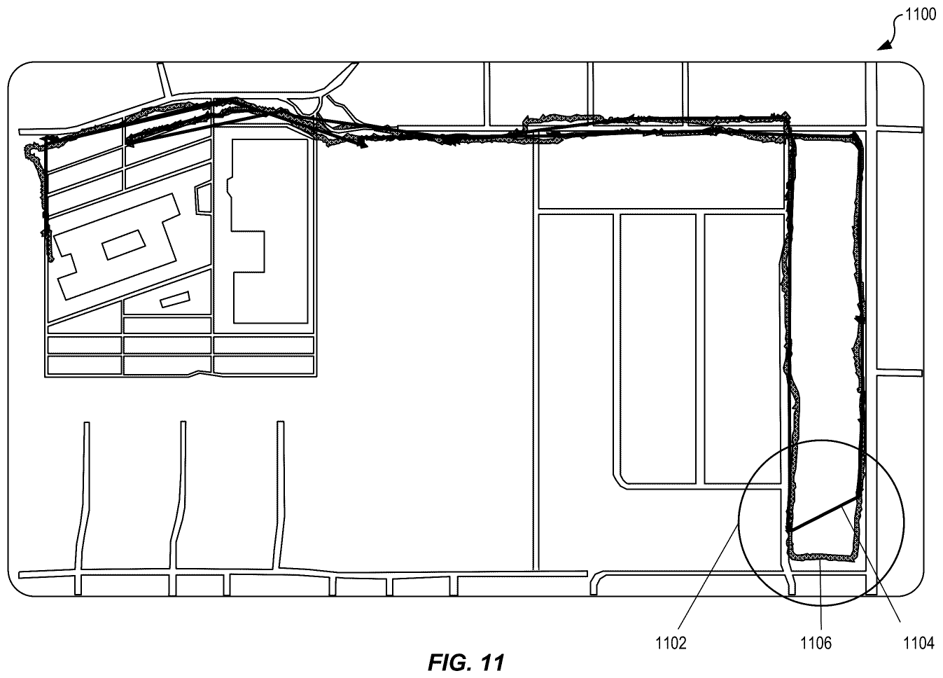

Referring back to FIG. 9, the odometry data 904 can be aligned with a coordinate system of the map data using the intermittent trajectory data 902. The coordinate system can be, for example, an ECEF coordinate system. By aligning the intermittent trajectory data 902 and the odometry data 904 to the maps data (e.g., maps data 412) a corresponding plurality of paths can be accessed from the maps unit. FIG. 11 is an illustration of intermittent trajectory data 902 and odometry data 904 aligned with a coordinate system, according to one or more embodiments. Referring to FIG. 11, it is illustrated that the intermittent trajectory data 902 and the odometry data 904 have been aligned to a coordinate system of the map data. Referring to area designated by the circle 1102, a slanted line 1104 indicating the two location points from FIG. 10 is illustrated (see, area in circle 1010). Furthermore, another odometry-based line 1106 is also illustrated. As illustrated, the odometry-based line 1106 can be based on odometry data that is collected at substantially the same time at the two location points used to form the slanted line. However, it can be seen that the odometry-based line more closely follows a general pattern of the surrounding segments, but is not quite aligned with the surrounding segments.

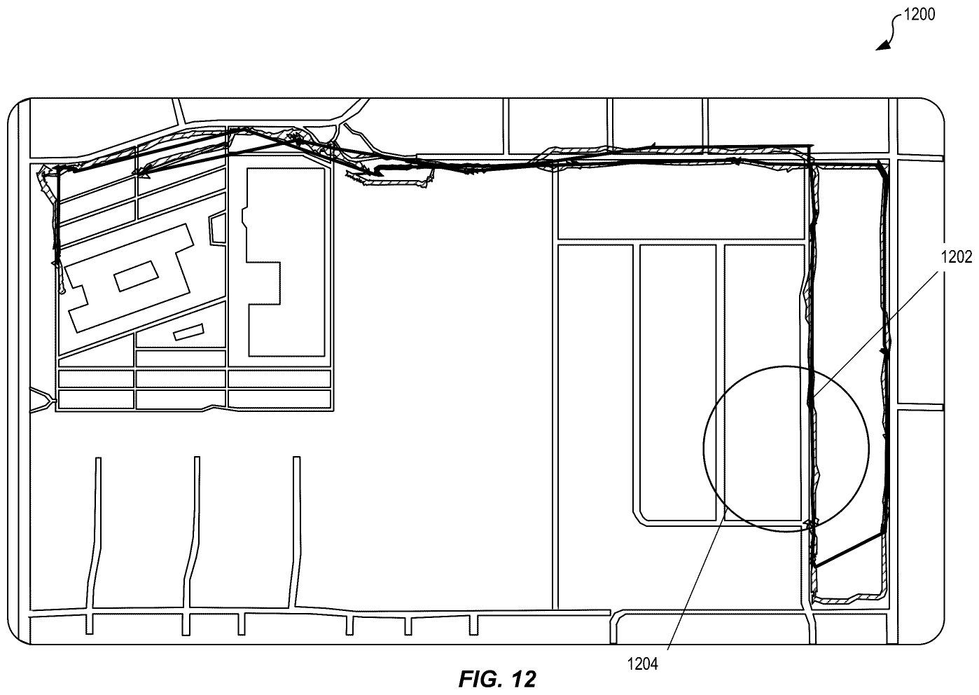

Referring back to FIG. 9, the following operation can be a snaps to map 908. Snapping to a map can include the determining a set of segments from the maps data are associated with the intermittent trajectory data. A pathfinding algorithm (e.g., A* search algorithm, Dijkstra algorithm, Greedy Best-First algorithm, or the like) can be used to determine a candidate set of segments that correspond to location points. For example, the first segment can be selected based on a proximity (e.g., a threshold distance) to the first location point. The second segment can also be selected based on a proximity to the second location point. FIG. 12 is an illustration 1200 of intermittent trajectory data and odometry data aligned with a map data, according to one or more embodiments. Referring to FIG. 12, it be seen that the route 1202 is aligning with the segments of the map data. Referring to area designated by the circle 1204 of FIG. 12 and looking back at the same area on FIG. 11, it is illustrated that the route 120 more or less follows the path of the segments in FIG. 12, whereas the same area in FIG. 11 shows the route veering off of the segments.

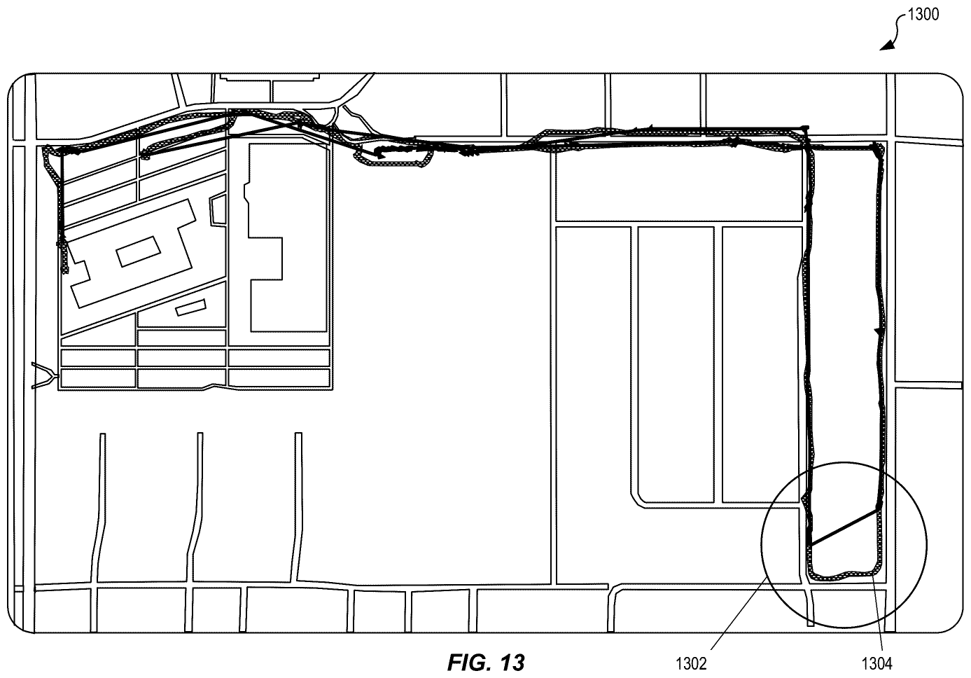

Referring back to FIG. 9, a next step can be to smooth 912 the candidate reconstructed route. As indicated above, in some instances, the corners of the reconstructed right are hard (non-human like) corners. Therefore, the process can include identifying angled corners and replacing the angled corners with rounded corners. FIG. 13 is an illustration of reconstructed route with smooth corners, according to one or more embodiments. Referring to FIG. 13, it can be seen in the area designated by the circle 1304, and in comparison to the same area in FIG. 12, that the corners have been smoothed out to give the visual representation of the reconstructed route a more human-like feel.

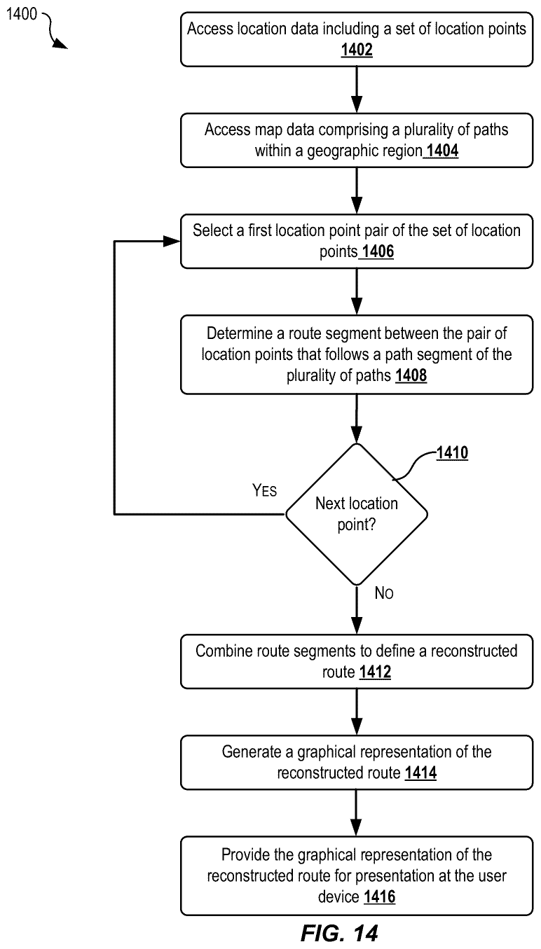

FIG. 14 is a process flow that corresponds to FIGS. 1-6, in that the user has enabled a use device to operate in a second operating mode (e.g., a low-power data collection mode) and the user has expressly requested that the user device record a workout. FIG. 14 illustrates a flowchart showing an example process 1400 for implementing techniques relating to route reconstruction using sparse location data, according to at least one example. The process 1400 may be performed by the user device 104 (e.g., a smartphone, a smartwatch, tablet, etc.). The process 1400 may include at least some portions that may be performed in real-time and some that may be performed in about real-time or shortly after a triggering event. For example, location data (e.g., intermittent trajectory data) may be collected in real-time, but a reconstructed route may be generated in about real-time responsive to a conclusion of a workout (e.g., a triggering event).

The process 1400 may begin at block 1402 by the user device accessing location data including a set of location points. The location points may have been collected by the user device during a workout. The set of location points may define an initial route. The set of location points may include an initial location point and a final location point. The user device may collect the location data during the workout using a sparse location data collection mode of a plurality of location data collection modes. In some examples, each location point may include a horizontal position and zero or more of the following properties: a horizontal position uncertainty, a vertical position, a vertical position uncertainty, a course, a course uncertainty, a speed, a speed uncertainty, a distance traveled, (e.g., a pedometer measurement), and a distance traveled uncertainty. In some examples, each location point may include other attributes including, for example, coordinates, altitude, logical floor of a building, a time stamp for when the data was determined, and information about the source that provides the location data.

At block 1404, the process 1400 includes the user device accessing map data including a plurality of paths within a geographic region. The geographic region may include a region in which the set of location points are located.

At block 1406, the process 1400 includes the user device selecting a first location point pair of the set of location points.

At block 1408, the process 1400 includes the user device, for the first pair of location points, determining a route segment between the pair of location points that follows a path segment of the plurality of paths.

At block 1410, the process 1400 includes the user device determining whether there is another location point in the set of location points. If yes, the process returns to block 1406 and iterates through evaluating the next location point pair. If no, the process proceeds to block 1412. At block 1412, the process 1400 includes the user device combining route segments for each location point pair of the plurality of location point pairs to define a reconstructed route. The reconstructed route may begin with a first location route pair based on the initial location point and may end with a second location route pair based on the final location point.

At block 1414, the process 1400 may include generating a graphical representation of the reconstructed route. For example, the process 1400 can include collecting intermittent trajectory data and odometry data by a user device. The intermittent trajectory data and the odometer data can be aligned with a coordinate system of map data. The user device can use a pathfinding algorithm to determine a path between locations points of the intermittent trajectory data. The path can be used to generate a reconstructed route. In some instances, the reconstructed route can include angled corners. In these instances, the user device can replace the angled corners with rounded corners.

At block 1416, the process 1400 may include providing the graphical representation of the reconstructed route for presentation at the user device.

In some examples, the user device may include a wearable mobile user device. In this example, accessing the location data, accessing the map data, determining the route segment, combining the route segment, generating the graphical representation, and providing the graphical representation are performed by the wearable user device.

In some examples, accessing the location data, accessing the map data, determining the route segment, and combining the route segment define a route reconstruction operation. In this example, the route reconstruction operation may be performed in response to at least one of detecting a conclusion of the workout or collecting the final location point. The route reconstruction operation may be performed in substantially real-time with at least one of detecting a conclusion of the workout or collecting the final location point. In some embodiments, the route reconstruction can be performed in real-time during the workout. For example, as the user is walking, the user device can reconstruct the route. Furthermore, the user device can generate the graphical representation of the reconstructed route in real-time. For example, as the user is walking, the user device can reconstruct the route and generate a graphical representation of the reconstructed that is displayed on the user device. Therefore, the user does not need to wait to the conclusion of the workout to view the graphical representation of the reconstructed route.

In some examples, the process 1400 may further include collecting the location data during the workout. In this example, accessing the location data, accessing the map data, determining the route segment, combining the route segment, generating the graphical representation, and providing the graphical representation are performed in real-time during the workout or after conclusion of the workout.

In some examples, determining a route segment for the plurality of location point pairs may include determining whether a shortest route segment that connects the respective pair of location points can be found.

In some examples, in the event that the shortest route segment along at least one of the plurality of paths cannot be found, the process 1400 may include accessing pedometer data associated with a time between when the pair of location points were collected, and using the pedometer data to generate a potential path segment between the pair of location points. The potential path segment, which may be referred to herein as an undefined route, avoids any of the plurality of paths. In this example, generating the graphical representation of the reconstructed route may include using a first graphical representation for the route segments and a second graphical representation for the potential path segment.

In some examples, the process 1400 may further include downloading the map data from a service provider, and caching the map data in memory of the user device. In this example, the map data may correspond to a geographic region. The geographic region may be determined by user device data relating to geographic location.

In some examples, the process 1400 may further include determining to use the sparse data collection mode based on contextual data.

In some examples, the process 1400 may further include determining to use the sparse data collection mode based a user input that selects the sparse data collection mode from among the plurality of location data collection modes.

In some examples, when in the sparse data collection mode, the user device may be configured to collect each location point at a first frequency of about every two minutes, and the reconstructed route may approximate collection of each location point at a second frequency of about every one second.

In some examples, the sparse data collection mode is configured to collect sparse location data as compared to a typical data collection mode.

In some examples, determining the route segment may include using a pathfinding technique. An A* search is an example.

In some examples, the initial route is unassociated with any paths of the plurality of paths. The reconstructed route may be associated with at least one path of the plurality of paths.

In some examples, the process 1400 may include generating a route distance based on the reconstructed route, and wherein the graphical representation of the reconstructed route comprises the route distance. In this example, the route distance is a reconstructed route distance. The initial route may be associated with an initial route distance. In some examples, the reconstructed route distance is greater than the initial route distance. In some examples, the reconstructed route distance is more accurate than the initial route distance with respect to an actual route the user device moved during the workout.

In some examples, each location point of the plurality of location points is determined by at least: turning on a location measurement device (e.g., location services system implemented by GPS, GNSS, or other location identification device), collecting a plurality of location measurements while the location measurement device is turned on, evaluating the plurality of location measurements with respect to a set of selection criteria (e.g., measured accuracy of the location measurements, etc.), and picking a particular location measurement of the plurality of location measurements as the location point based on evaluating the plurality of location measurements with respect to the set of selection criteria.

In some examples, the process 1400 may further include accessing user behavior data associated with a behavior of a user of the user device. This may include determining each route segment is based at least in part on the user behavior data.

In some examples, the process 1400 may further include receiving a first user input to begin the workout, and receiving a second user input to conclude the workout.

In some examples, the graphical representation of the reconstructed route may include a line that represents the reconstructed route. In this example, providing the graphical representation may include providing the graphical representation overlaid on a map view.

In some examples, determining the route segment between the pair of location points that follows the path segment of the plurality of paths may include map matching the plurality of location point pairs to path segments of the plurality of path segments.

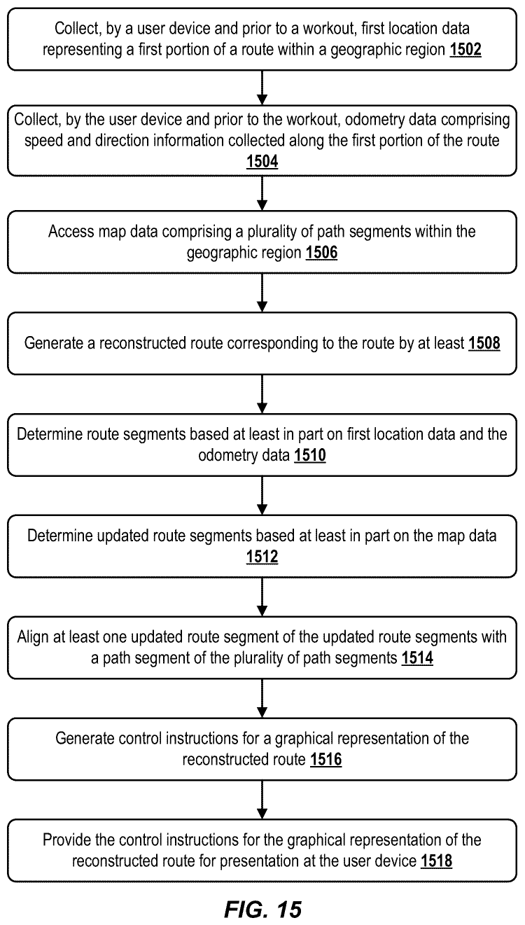

FIG. 15 is a process 1500 that corresponds to FIGS. 7-13, in that the user has not expressly enabled a user device to record a workout. The process flow 1500 therefore corresponds to the first operating mode that includes collecting a dynamic data collection mode. FIG. 15 illustrates a flowchart showing an example process 1500 for implementing techniques relating to route reconstruction using sparse location data, according to at least one example. At block 1502, the process 1500 can include a user device (e.g., user device 104) collecting first location data (e.g., intermittent trajectory data) representing a first portion of a route within a geographic region. The first location data can be collected prior to a user beginning a workout on the user device. In some embodiments, the user device collect the first location data comprises in response to determining that the odometry data is indicative of a beginning of a physical activity. It should be appreciated that although the techniques here are described with respect to reconstructing a first portion of a route, the techniques can be used for reconstructing an entire route or multiple distinct portions of the route.

At block 1504, the process can include the user device collecting, odometry data including speed and direction information collected along at least one portion of the route. The odometry data can include, for example, velocity data, acceleration data, directional data, and the like. In some examples, the odometry data is collected for a period of time prior to the user device collecting the first location data. For example, as described with respect to FIG. 7, the odometry data may be collected about continuously, and may be used to detect when the user begins to engage in physical activity (e.g., begins a walk, begins a run, begins a bike ride, etc.).

At block 1506, the process 1500 can include the user device accessing map data including a plurality of path segments within the geographic region. The path segments can include length data and directional data identifying a movement for traversing a path. The user device can align the first location data to a coordinate system of the map data. The user device can further align the odometry data to the coordinate system of the map data. The reconstructed route is determined based at least in part on the coordinate system of the map data. In some embodiments, route reconstruction (including accessing the map data) is performed in response to detecting a conclusion of the workout. As indicated above, the route reconstruction can be also performed in real-time during the workout. For example, as the user is walking, the user device can reconstruct the route. Furthermore, the user device can generate the graphical representation of the reconstructed route in real-time. For example, as the user is walking, the user device can reconstruct the route and generate a graphical representation of the reconstructed that is displayed on the user device. Therefore, the user does not need to wait to the conclusion of the workout to view the graphical representation of the reconstructed route.

At block 1508, the process 1500 can include the user device generating a reconstructed route corresponding to the route by at least blocks 1510-1514.

At block 1510, the process 1500 can include the user device determining route segments based at least in part on first location data (e.g., intermittent trajectory data 902) and the odometry data (IO data 904). The user device can identify a plurality of candidate intermediate path segments from the map data. The user device can further determine one or more candidate intermediate path segments connecting the first path segment to the second path segment. For example, the user device can use a pathfinder algorithm to determine one or more candidate intermediate segments connecting the first path segment to the second path segment. The one or more intermediate path segments can be a shortest connection of the first path segment to the second path segment. For example, the user device can compare a first length of the first set of candidate intermediate path segments to a second length of the second set of candidate intermediate path segments to determine the shortest connection.

At block 1512, the process 1500 can include the user device determining updated route segments based at least in part on the map data. The updated route can include the determined path segments to be used to generate the reconstructed route.

At block 1514, the process 1500 can include the user device aligning at least one updated route segment of the updated route segments with a path segment of the plurality of path segments. The user device can align the first location data to a coordinate system of the map data. The user device can further align the odometry data to the coordinate system of the map data. The user device can identify a rectangular corner of the reconstructed route. The user device can further smooth the rectangular corner to convert the rectangular corner to a rounded corner. The reconstructed route is determined based at least in part on the coordinate system of the map data.

In some embodiments, the user device can further collect second location data during the workout. The second location data can be associated with a second portion of the route. The first location data can be collected according to a first data collection frequency of a first operating mode. The second location data can be collected according to a second data collection frequency of the first operating mode. In some embodiments, the second frequency is greater than the first frequency.

The reconstructed route can include the at least one updated route segment. In some embodiments, the user device can further smooth out angled corners of the route. For example, a smoother unit (e.g., smoother unit 830) of the user device can identify a rectangular corner of the reconstructed route. The user device can then smooth the rectangular corner to convert the rectangular corner to a rounded corner.

At block 1516, the process 1500 can include the user device generating control instructions for a graphical representation of the reconstructed route. The control instructions can define how the reconstructed route is to be visualized on the display of the user device.

At block 1518, the process 1500 can include the user device providing the control instructions for the graphical representation of the reconstructed route for presentation at the user device. The visual representation of the reconstructed route can be displayed on a display of the user device.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

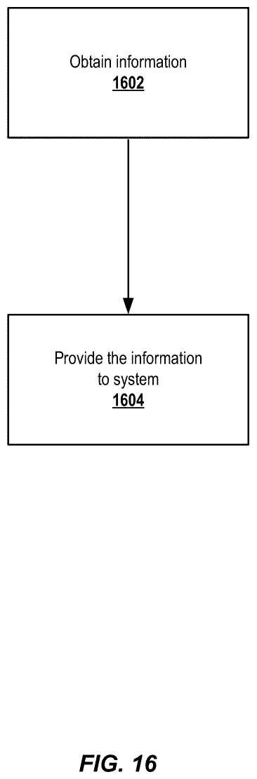

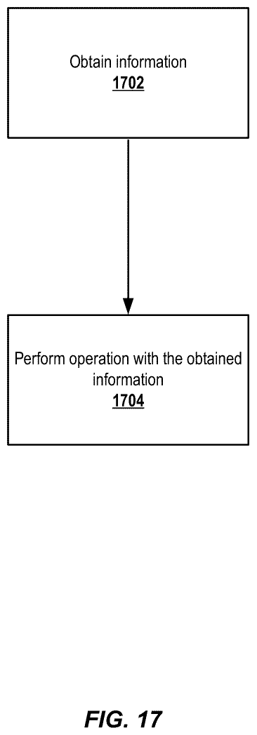

Implementations within the scope of the present disclosure include a computer-readable storage medium that encodes instructions organized as an application (e.g., application 1804) that, when executed by one or more processing units, control an electronic device (e.g., device 1802) to perform the method of FIG. 16, the method of FIG. 17, and/or one or more other processes and/or methods described herein.

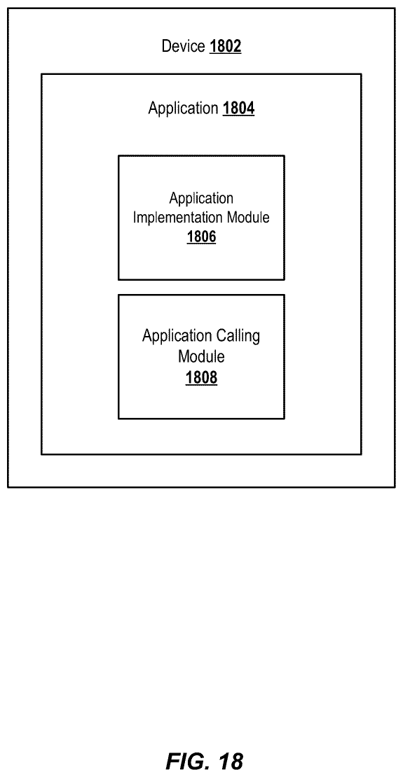

It should be recognized that application 1804 (shown in FIG. 18) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1804 is an application that is pre-installed on device 1802 at purchase (e.g., a first party application). In other embodiments, application 1804 is an application that is provided to device 1802 via an operating system update file (e.g., a first party application or a second party application). In other embodiments, application 1804 is an application that is provided via an application store. In some embodiments, the application store can be an application store that is pre-installed on device 1802 at purchase (e.g., a first party application store). In other embodiments, the application store is a third-party application store (e.g., an application store that is provided by another application store, downloaded via a network, and/or read from a storage device).

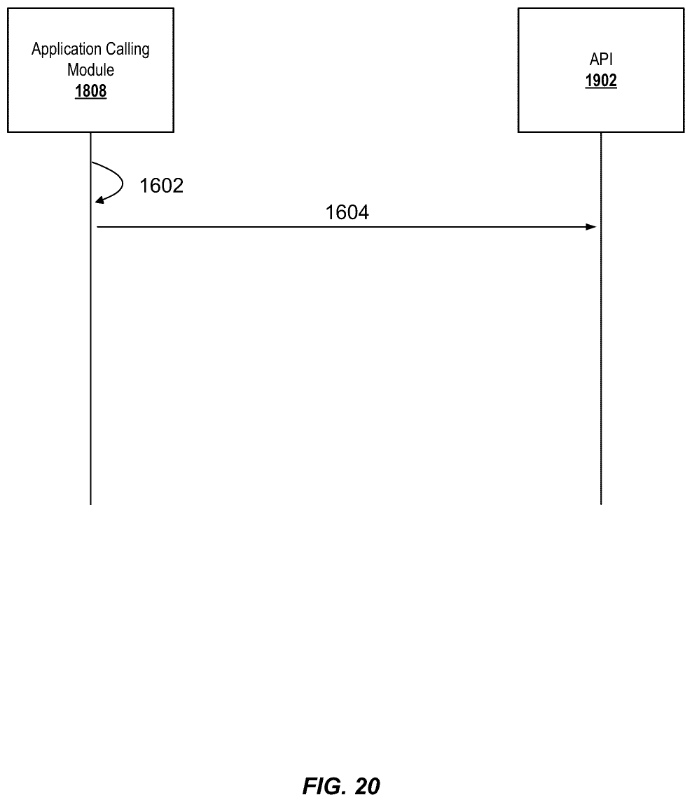

Referring to FIG. 16 and FIG. 20, application 1804 obtains information (e.g., 1602). In some embodiments, at 1602, information is obtained from at least one hardware component of the device 1802. In some embodiments, at 1602, information is obtained from at least one software module of the device 1802. In some embodiments, at 1602, information is obtained from at least one hardware component external to the device 1802(e.g., a peripheral device, an accessory device, a server, etc.). In some embodiments, the information obtained at 1602 includes positional information, time information, notification information, user information, environment information, electronic device state information, weather information, media information, historical information, event information, hardware information, and/or motion information. In some embodiments, in response to and/or after obtaining the information at 1602, application 1804 provides the information to a system (e.g., 1604).

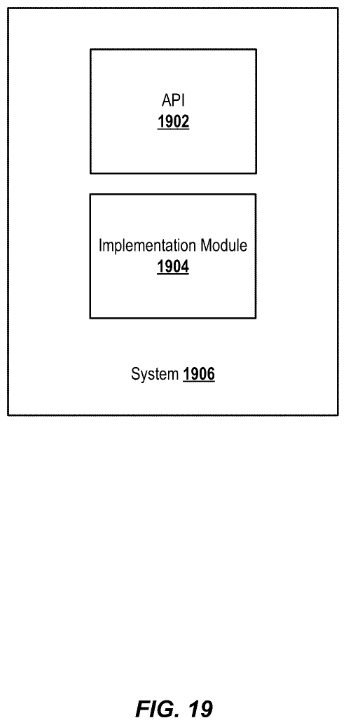

In some embodiments, the system (e.g., 1906 shown in FIG. 19) is an operating system hosted on the device 1802. In some embodiments, the system (e.g., 1906 shown in FIG. 19) is an external device (e.g., a server, a peripheral device, an accessory, a personal computing device, etc.) that includes an operating system.

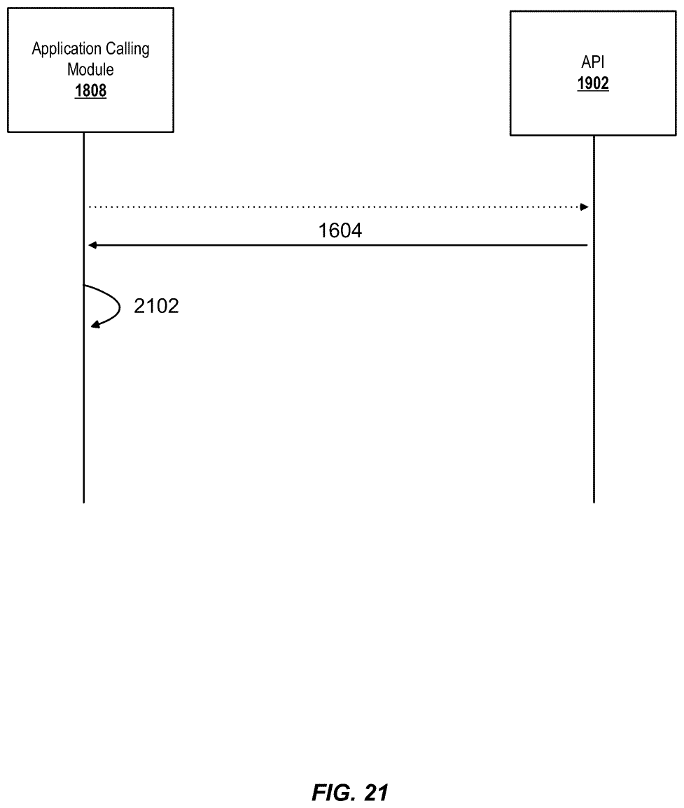

Referring to FIG. 17 and FIG. 21, application 1804 obtains information (e.g., 1704). In some embodiments, the information obtained at 1704 includes positional information, time information, notification information, user information, environment information electronic device state information, weather information, media information, historical information, event information, hardware information and/or motion information. In response to and/or after obtaining the information at 1704, application 1804 performs an operation with the information (e.g., 2102). In some embodiments, the operation performed at 2102 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1906 based on the information.

In some embodiments, one or more steps of the method of FIG. 16 and/or the method of FIG. 17 is performed in response to a trigger. In some embodiments, the trigger includes detection of an event, a notification received from system 1906, a user input, and/or a response to a call to an API provided by system 1906.

In some embodiments, the instructions of application 1804, when executed, control device 1802 to perform the method of FIG. 16 and/or the method of FIG. 17 by calling an application programming interface (API) (e.g., API 1902) provided by system 1906. In some embodiments, application 1804 performs at least a portion of the method of FIG. 16 and/or the method of FIG. 17 without calling API 1902.

In some embodiments, one or more steps of the method of FIG. 16 and/or the method of FIG. 17 includes calling an API (e.g., API 1902) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 18, device 1802 is illustrated. In some embodiments, device 1802 is a personal computing device, a smart phone, a smart watch, a fitness tracker, a head mounted display (HMD) device, a media device, a communal device, a speaker, a television, and/or a tablet. As illustrated in FIG. 18, device 1802 includes application 1804 and operating system (e.g., system 1906 shown in FIG. 19). Application 1804 includes application implementation module 1806 and API calling module 1808. System 1906 includes API 1902 and implementation module 1904. It should be recognized that device 1802, application 1804, and/or system 1906 can include more, fewer, and/or different components than illustrated in FIGS. 18 and 19.

In some embodiments, application implementation module 1806 includes a set of one or more instructions corresponding to one or more operations performed by application 1804. For example, when application 1804 is a messaging application, application implementation module 1806 can include operations to receive and send messages. In some embodiments, application implementation module 1806 communicates with API calling module to communicate with system 1906 via API 1902 (shown in FIG. 19).

In some embodiments, API 1902 is a software module (e.g., a collection of computer-readable instructions) that provides an interface that allows a different module (e.g., API calling module 1808) to access and/or use one or more functions, methods, procedures, data structures, classes, and/or other services provided by implementation module 1904 of system 1906. For example, API-calling module 1808 can access a feature of implementation module 1904 through one or more API calls or invocations (e.g., embodied by a function or a method call) exposed by API 1902 and can pass data and/or control information using one or more parameters via the API calls or invocations. In some embodiments, API 1902 allows application 1804 to use a service provided by a Software Development Kit (SDK) library. In other embodiments, application 1804 incorporates a call to a function or method provided by the SDK library and provided by API 1902 or uses data types or objects defined in the SDK library and provided by API 1902. In some embodiments, API-calling module 1808 makes an API call via API 1902 to access and use a feature of implementation module 1904 that is specified by API 1902. In such embodiments, implementation module 1904 can return a value via API 1902 to API-calling module 1808 in response to the API call. The value can report to application 1804 the capabilities or state of a hardware component of device 1802, including those related to aspects such as input capabilities and state, output capabilities and state, processing capability, power state, storage capacity and state, and/or communications capability. In some embodiments, API 1902 is implemented in part by firmware, microcode, or other low level logic that executes in part on the hardware component.

In some embodiments, API 1902 allows a developer of API-calling module 1808 (which can be a third-party developer) to leverage a feature provided by implementation module 1904. In such embodiments, there can be one or more API-calling modules (e.g., including API-calling module 1808) that communicate with implementation module 1904. In some embodiments, API 1902 allows multiple API-calling modules written in different programming languages to communicate with implementation module 1904 (e.g., API 1902 can include features for translating calls and returns between implementation module 1904 and API-calling module 1808) while API 1902 is implemented in terms of a specific programming language. In some embodiments, API-calling module 1808 calls APIs from different providers such as a set of APIs from an OS provider, another set of APIs from a plug-in provider, and/or another set of APIs from another provider (e.g., the provider of a software library) or creator of the another set of APIs.

Examples of API 1902 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1802. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1904 is a system (e.g., operating system, server system) software module (e.g., a collection of computer-readable instructions) that is constructed to perform an operation in response to receiving an API call via API 1902. In some embodiments, implementation module 1904 is constructed to provide an API response (via API 1902) as a result of processing an API call. By way of example, implementation module 1904 and API-calling module 180 can each be any one of an operating system, a library, a device driver, an API, an application program, or other module. It should be understood that implementation module 1904 and API-calling module 1808 can be the same or different type of module from each other. In some embodiments, implementation module 1904 is embodied at least in part in firmware, microcode, or other hardware logic.

In some embodiments, implementation module 1904 returns a value through API 1902 in response to an API call from API-calling module 1808. While API 1902 defines the syntax and result of an API call (e.g., how to invoke the API call and what the API call does), API 1902 might not reveal how implementation module 1904 accomplishes the function specified by the API call. Various API calls are transferred via the one or more application programming interfaces between API-calling module 1808 and implementation module 1904. Transferring the API calls can include issuing, initiating, invoking, calling, receiving, returning, and/or responding to the function calls or messages. In other words, transferring can describe actions by either of API-calling module 1808 or implementation module 1904. In some embodiments, a function call or other invocation of API 1902 sends and/or receives one or more parameters through a parameter list or other structure.

In some embodiments, implementation module 1904 provides more than one API, each providing a different view of or with different aspects of functionality implemented by implementation module 1904. For example, one API of implementation module 1904 can provide a first set of functions and can be exposed to third party developers, and another API of implementation module 1904 can be hidden (e.g., not exposed) and provide a subset of the first set of functions and also provide another set of functions, such as testing or debugging functions which are not in the first set of functions. In some embodiments, implementation module 1904 calls one or more other components via an underlying API and thus be both an API calling module and an implementation module. It should be recognized that implementation module 1904 can include additional functions, methods, classes, data structures, and/or other features that are not specified through API 1902 and are not available to API calling module 1808. It should also be recognized that API calling module 1808 can be on the same system as implementation module 1904 or can be located remotely and access implementation module 1904 using API 1902 over a network. In some embodiments, implementation module 1904, API 1902, and/or API-calling module 1808 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, methods 1400 and 1500 (FIGS. 14 and 15) is performed at a first computer system (as described herein) via a system process (e.g., an operating system process, a server system process) that is different from one or more applications executing and/or installed on the first computer system.

In some embodiments, methods 1400 and 1500 (FIGS. 14 and 15) is performed at a first computer system (as described herein) by an application that is different from a system process. In some embodiments, the instructions of the application, when executed, control the first computer system to perform method 1400 (FIG. 14) by calling an application programming interface (API) provided by the system process. In some embodiments, the application performs at least a portion of method 1400 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1802) that runs the application. In some embodiments, the implementation module is included in an electronic device that is separate from the device that runs the application.

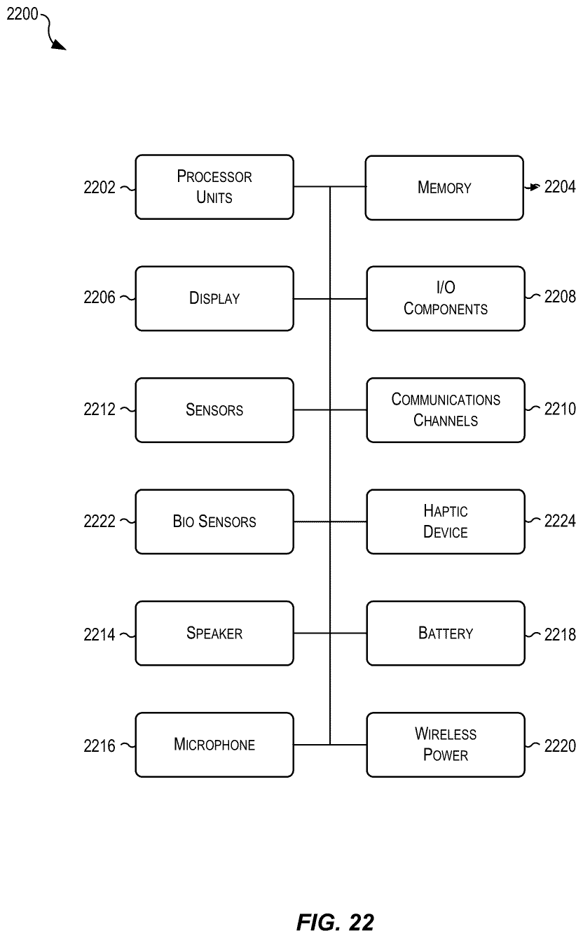

FIG. 22 depicts an example schematic diagram of a wearable electronic device 2200, according to one or more embodiments. The wearable electronic device 2200 is an example of the wearable user device 104. As shown in FIG. 22, the device 2200 includes one or more processing units 2202 that are configured to access a memory 2204 having instructions stored thereon.

Memories 2204, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 2204 is an example of non-transitory computer storage media. Additional types of computer storage media that may be present in the user device 2200 may include, but are not limited to, phase-change RAM (PRAM), SRAM, DRAM, RAM, ROM, EEPROM, flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 2300. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The instructions or computer programs may be configured to perform one or more of the operations or functions described with respect to the device 2200. For example, the instructions may be configured to control or coordinate the operation of the various components of the device. Such components include, but are not limited to, display 2206, one or more input/output components 2208, one or more communication channels 2210, one or more sensors 2212, a speaker 2214, microphone 2216, a battery 2218, wireless power 2220, bio sensors 2222, and/or one or more haptic feedback devices 2224. In some examples the speaker and microphone may be combined into a single unit and/or may share a common port through a housing of the device.

The processing units 2202 of FIG. 22 may be implemented as any electronic device capable of processing, receiving, or transmitting data or instructions. For example, the processing units 2202 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

As shown in FIG. 22, the device 2200 may also include one or more acoustic elements, including a speaker 2214 and/or a microphone 2216. The speaker 2214 may include drive electronics or circuitry and may be configured to produce an audible sound or acoustic signal in response to a command or input. Similarly, the microphone 2216 may also include drive electronics or circuitry and is configured to receive an audible sound or acoustic signal in response to a command or input. The speaker 2214 and the microphone 2216 may be acoustically coupled to a port or opening in the case that allows acoustic energy to pass, but may prevent the ingress of liquid and other debris.

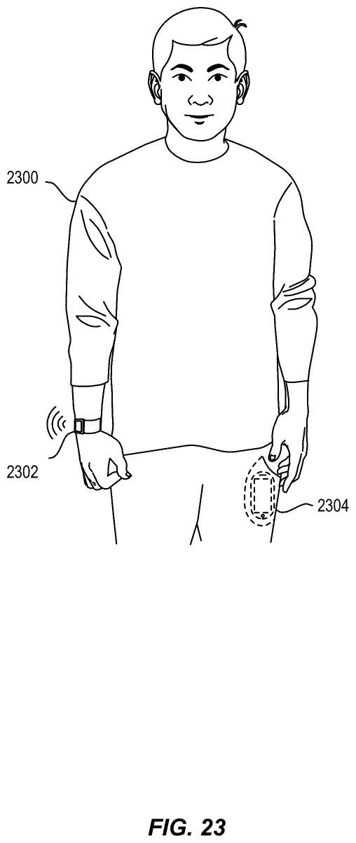

The example electronic device may communicate with other electronic devices either through a wired connection or wirelessly. Data may be passed between devices, permitting one device to relay information to another; control another; employ another's sensors, outputs, and/or inputs; and so on. FIG. 23 depicts a user 2300 wearing a first electronic device 2302 with a second electronic device 2304 in his pocket, according to one or more embodiments. Data may be wirelessly transmitted between the electronic devices 2302, 2304, thereby permitting the user 2300 to receive, view, and interact with data from the second device 2304 by means of the first electronic device 2302. Thus, the user 2300 may have access to part or all of the second device's functionality through the first electronic device 2302 without actually needing to interact directly with the second device 2304. In some examples, the second electronic device 2304 may be an example of the user device 104. The first electronic device 2202 may be an example of the wearable user device 104.

Further, the electronic devices 2302, 2304 may cooperate not only to share data, but to share functionality as well. For example, one of the two devices may incorporate a sensor, application, or function that the other lacks. The electronic device lacking such capabilities may request them from the other device, which may share wirelessly with the requesting device. Thus, multiple devices may operate together to provide expanded functions, software, access, and the like between the two and ultimately to a user. As one non-limiting example, the electronic device 2302 may be unable to place or receive telephone calls while the second device 2304 may be able to do so. A user may nonetheless make and/or receive calls through the first device 2302, which may employ the second device 2304 to actually place or accept a call.

As another non-limiting example, an electronic device 2302 may wirelessly communicate with a sales terminal nearby, thus permitting a user to quickly and efficiently conduct a transaction such as selling, buying, or returning a good. The electronic device may use near field communications technology to perform these and other functions.

As mentioned above, a band may be connected to two electronic devices and may serve as a wired communication path between the two. As another example, the devices may communicate wirelessly, thereby permitting one device to relay information from a second to a user. This latter example may be particularly useful when the second is inaccessible.

Certain examples may incorporate one or more biometric sensors to measure certain physiological characteristics of a user. The device may include a photoplesymogram sensor to determine a user's heart rate or blood oxygenation levels, for example. The device may also or instead include electrodes to measure the body impedance of a user, which may permit the device to estimate body fat percentages, the body's electrical activity, body impedance, and so on. Also include blood pressure, ultraviolet exposure, etc. Depending on the sensors incorporated into or associated with the electronic device, a variety of user characteristics may be measured and/or estimated, thereby permitting different health data to be provided to a user. In some examples, the sensed biometric data may be used, in part, to determine the historic, current, and/or predicted activity data of the user.

Certain examples may be wirelessly charged. For example, an inductive charging base may transmit power to an inductive receiver within the device in order to charge a battery of the device. Further, by varying the inductive field between the device and base, data may be communicated between the two. As one simple non-limiting example, this may be used to wake the base from a low-power sleep state to an active charging state when the device is placed on the base. Other wireless charging systems may also be used (e.g., near field magnetic resonance and radio frequency). Alternatively, the device may also employ wired charging through electrodes.

In certain examples, the device may include a rotary input, which may take the form of a crown with a stem. The crown and stem may be rotated to provide the rotary input. Rotation of the stem and/or crown may be sensed optically, electrically, magnetically, or mechanically. Further, in some examples the crown and stem may also move laterally, thereby providing a second type of input to the device.

The electronic device may likewise include one or more buttons. The button(s) may be depressed to provide yet another input to the device. In various examples, the button may be a dome switch, rocker switch, electrical contact, magnetic switch, and so on. In some examples the button may be waterproof or otherwise sealed against the environment.

Various examples may include or otherwise incorporate one or more motion sensors. A motion sensor (e.g., odometry sensor) may detect motion of the device and provide, modify, cease, or otherwise affect a state, output, or input of the device or associated applications based at least in part on the motion. As non-limiting examples, a motion may be used to silence the device or acknowledge an alert generated by the device. Sample motion sensors include accelerometers, gyroscopic sensors, magnetometers, GPS sensors, distance sensors, and so on. Some examples may use a GPS sensor to facilitate or enable location and/or navigation assistance.

These and other functions, operations, and abilities of the electronic device will be apparent upon reading the specification in its entirety.

Certain examples of a wearable electronic device may include one or more sensors that can be used to calculate a health metric or other health-related information. As one example, a wearable electronic device may function as a wearable health assistant that provides health-related information (whether real-time or not) to the user, authorized third parties, and/or an associated monitoring device.

FIG. 25 illustrates an example architecture or environment 2500 configured to implement techniques relating to reconstructed routes using sparse location data, according to at least one example. In some examples, the example architecture 2500 may further be configured to enable a wearable electronic user device 2504 (e.g., the user device 104), a service provider computer 2503, and a handheld user device 2502 to share information. In some examples, the devices may be connected via one or more networks 2508 and/or 2506(e.g., via Bluetooth, WiFi, the Internet, or the like). In the architecture 2500, one or more users may utilize the user device 2502 to manage, control, or otherwise utilize the wearable electronic device 2504, via the one or more networks 2506. Additionally, in some examples, the wearable electronic device 2504, the service provider computers 2503, and the user device 2502 may be configured or otherwise built as a single device. For example, the wearable electronic device 2504 and/or the user device 2502 may be configured to implement the examples described herein as a single computing unit, exercising the examples described above and below without the need for the other devices described.

In some examples, the networks 2506, 2508 may include any one or a combination of many different types of networks, such as cable networks, the Internet, wireless networks, cellular networks, satellite networks, other private and/or public networks, or any combination thereof. While the illustrated example represents the user device 2502 accessing the service provider computers 2503 via the networks 2508, the described techniques may equally apply in instances where the user device 2502 interacts with the service provider computers 2503 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

As noted above, the user device 2502 may be configured to collect and/or manage user activity data potentially received from the wearable electronic device 2504. In some examples, the wearable electronic device 2504 may be configured to provide health, fitness, activity, and/or medical data of the user to a third- or first-party application (e.g., the service provider computer 2503). In turn, this data may be used by the user device 2502 to identify trends and/or for sharing. The user device 2502 may be any type of computing device such as, but not limited to, a mobile phone, a smartphone, a personal digital assistant (PDA), a laptop computer, a desktop computer, a thin-client device, a tablet computer, a wearable device, or the like. In some examples, the user device 2502 may be in communication with the service provider computers 2503 and/or the wearable electronic device 2504 via the networks 2508, 2506, or via other network connections.

In one illustrative configuration, the wearable user device 2504 (and the user device 2502) may include at least one memory 2514 and one or more processing units (or processor(s)) 2516. The processor(s) 2516 may be implemented as appropriate in hardware, computer-executable instructions, firmware, or combinations thereof. Computer-executable instruction or firmware implementations of the processor(s) 2516 may include computer-executable or machine-executable instructions written in any suitable programming language to perform the various functions described. The wearable user device 2504 may also include geo-location devices (e.g., a global positioning system (GPS) device or the like) for providing and/or recording geographic location information associated with the wearable user device 2504. In some examples, the wearable user device 2504 may also include geo-location devices for providing and/or recording geographic location information associated with user device 2502.

The memory 2514 may store program instructions that are loadable and executable on the processor(s) 2516, as well as data generated during the execution of these programs. Depending on the configuration and type of the wearable user device 2504, the memory 2514 may be volatile (such as random access memory (RAM)) and/or non-volatile (such as read-only memory (ROM), flash memory, etc.). The wearable user device 2504 may also include additional removable storage and/or non-removable storage 2526 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 2514 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 2514 and the additional storage 2526, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 2514 and the additional storage 2526 are both examples of non-transitory computer storage media. Additional types of computer storage media that may be present in the user device 254 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the wearable user device 2504. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The wearable user device 2504 may also contain communications connection(s) 2528 that allow the wearable user device 2504 to communicate with a data store, another computing device or server, user terminals, and/or other devices via the networks 2508, 2506. The wearable user device 2504 may also include I/O device(s) 2530, such as a keyboard, a mouse, a pen, a voice input device, a touch input device, a display, an operating system 2532 and/or one or more application programs or services for implementing the features disclosed herein including a route application 2510(1). In some examples, the route application 2510(1) may be configured to implement the features described herein. For example, the route application may be used to record workouts, change settings relating to location collection mode, compute reconstructed routes, and the like. The user device 2502 may include a memory that includes a similar route application 2510(2), which may be accessible by one or more processors of the user device 2502. The service provider computer 2503 may also include a memory 2542 that includes a route application 2510(3). In this manner, the techniques described herein may be implemented by any one, or a combination of more than one, of the computing devices (e.g., the wearable user device 2505, the wearable user device 2504, or the service provider computer 2503).

The service provider computers 2503 may also be any type of computing device such as, but not limited to, a mobile phone, a smartphone, a PDA, a laptop computer, a desktop computer, a thin-client device, a tablet computer, a wearable device, a server computer, a virtual machine instance, etc. In some examples, the service provider computers 2503 may be in communication with the user device 2502 and/or the wearable user device 2505 via the networks 2508, 2506, or via other network connections.

In one illustrative configuration, the service provider computers 2503 may include at least one memory 2542 and one or more processing units (or processor(s)) 2544. The processor(s) 2544 may be implemented as appropriate in hardware, computer-executable instructions, firmware, or combinations thereof. Computer-executable instruction or firmware implementations of the processor(s) 2544 may include computer-executable or machine-executable instructions written in any suitable programming language to perform the various functions described.

The memory 2542 may store program instructions that are loadable and executable on the processor(s) 2544, as well as data generated during the execution of these programs. Depending on the configuration and type of service provider computer 2503, the memory 2542 may be volatile (such as RAM) and/or non-volatile (such as ROM, flash memory, etc.). The service provider computer 2503 may also include additional removable storage and/or non-removable storage 2546 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 2542 may include multiple different types of memory, such as SRAM, DRAM, or ROM. While the volatile memory described herein may be referred to as RAM, any volatile memory that would not maintain data stored therein once unplugged from a host and/or power would be appropriate. The memory 2542 and the additional storage 2546, both removable and non-removable, are both additional examples of non-transitory computer-readable storage media.

The service provider computer 2503 may also contain communications connection(s) 2548 that allow the service provider computer 2503 to communicate with a data store, another computing device or server, user terminals and/or other devices via the networks 2508, 2506. The service provider computer 2503 may also include I/O device(s) 2550, such as a keyboard, a mouse, a pen, a voice input device, a touch input device, a display, speakers, a printer, etc.

Turning to the contents of the memory 2542 in more detail, the memory 2542 may include an operating system 2552 and/or one or more application programs or services for implementing the features disclosed herein including the route application 2510(3).

Examples described herein may take the form of, be incorporated in, or operate with a suitable wearable electronic device. One example of such a device is shown in FIG. 9 and takes the form of a wearable mechanism 900, which is an example of the user device 104. As shown, the mechanism 900 may be worn on a user's wrist and secured thereto by a band. The mechanism 900 may have a variety of functions including, but not limited to: keeping time; monitoring a user's physiological signals and providing health-related information based at least in part on those signals; communicating (in a wired or wireless fashion) with other electronic devices, which may be different types of devices having different functionalities; providing alerts to a user, which may include audio, haptic, visual and/or other sensory output, any or all of which may be synchronized with one another; visually depicting data on a display; gathering data from one or more sensors that may be used to initiate, control, or modify operations of the device; determining a location of a touch on a surface of the device and/or an amount of force exerted on the device, and using either or both as input; accepting voice input to control one or more functions; accepting tactile input to control one or more functions; and so on.

Alternative examples of suitable electronic devices include a phone; a tablet computing device; a portable media player; and so on. Still other suitable electronic devices may include laptop/notebook computers, personal digital assistants, touch screens, input-sensitive pads or surfaces, and so on.

In some examples the electronic device may accept a variety of bands, straps, or other retention mechanisms (collectively, “bands”). These bands may be removably connected to the electronic device by a lug that is accepted in a recess or other aperture within the device and locks thereto. The lug may be part of the band or may be separable (and/or separate) from the band. Generally, the lug may lock into the electronic device's recess and thereby maintain connection between the band and device. The user may release a locking mechanism to permit the lug to slide or otherwise move out of the recess. In some examples, the recess may be formed in the band and the lug may be affixed or incorporated into the device.

A user may change combinations of bands and electronic devices, thereby permitting mixing and matching of the two categories. It should be appreciated that devices having other forms and/or functions may include similar recesses and may releasably mate with a lug and/or band incorporating a lug. In this fashion, an ecosystem of bands and devices may be envisioned, each of which is compatible with another. A single band may be used to connect to devices, as one further example; in such examples the band may include electrical interconnections that permit the two devices to transmit signals to one another and thereby interact with one another.

In many examples, the electronic device may keep and display time, essentially functioning as a wristwatch among other things. Time may be displayed in an analog or digital format, depending on the device, its settings, and (in some cases) a user's preferences. Typically, time is displayed on a digital display stack forming part of the exterior of the device.

The display stack may include a cover element, such as a cover glass, overlying a display. The cover glass need not necessarily be formed from glass, although that is an option; it may be formed from sapphire, zirconia, alumina, chemically strengthened glass, hardened plastic and so on. Likewise, the display may be a liquid crystal display, an organic light-emitting diode display, or any other suitable display technology. Among other elements, the display stack may include a backlight in some examples.

The device may also include one or more touch sensors to determine a location of a touch on the cover glass. A touch sensor may be incorporated into or on the display stack in order to determine a location of a touch. The touch sensor may be self-capacitive in certain examples, mutual-capacitive in others, or a combination thereof.

Similarly, the device may include a force sensor to determine an amount of force applied to the cover glass. The force sensor may be a capacitive sensor in some examples and a strain sensor in other examples. In either example, the force sensor is generally transparent and made from transparent materials, or is located beneath or away from the display in order not to interfere with the view of the display. The force sensor may, for example, take the form of two capacitive plates separated by silicone or another deformable material. As the capacitive plates move closer together under an external force, the change in capacitance may be measured and a value of the external force correlated from the capacitance change. Further, by comparing relative capacitance changes from multiple points on the force sensor, or from multiple force sensors, a location or locations at which force is exerted may be determined. In one example the force sensor may take the form of a gasket extending beneath the periphery of the display. The gasket may be segmented or unitary, depending on the example.

The electronic device may also provide alerts to a user. An alert may be generated in response to: a change in status of the device (one example of which is power running low); receipt of information by the device (such as receiving a message); communications between the device and another mechanism/device (such as a second type of device informing the device that a message is waiting or communication is in progress); an operational state of an application (such as, as part of a game, or when a calendar appointment is imminent) or the operating system (such as when the device powers on or shuts down); and so on. The number and types of triggers for an alert are various and far-ranging.

The alert may be auditory, visual, haptic, or a combination thereof. A haptic actuator may be housed within the device and may move linearly to generate haptic output (although in alternative examples the haptic actuator may be rotary or any other type). A speaker may provide auditory components of an alert and the aforementioned display may provide visual alert components. In some examples a dedicated light, display, or other visual output component may be used as part of an alert.

The auditory, haptic, and/or visual components of the alert may be synchronized to provide an overall experience to a user. One or more components may be delayed relative to other components to create a desired synchronization among them. The components may be synchronized so that they are perceived substantially simultaneously; as one example, a haptic output may be initiated slightly before an auditory output since the haptic output may take longer to be perceived than the audio. As another example, a haptic output (or portion thereof) may be initiated substantially before the auditory output, but at a weak or even subliminal level, thereby priming the wearer to receive the auditory output.

### EXAMPLES

In the following sections, further example embodiments are provided.

Example 1 can include a computer-implemented method, comprising: accessing location data comprising a set of location points collected by a user device during a workout and defining an initial route, the set of location points comprising an initial location point and a final location point, wherein the user device collects the location data during the workout using a sparse location data collection mode of a plurality of location data collection modes; accessing map data comprising a plurality of paths within a geographic region; for a plurality of location point pairs of the set of location points, determining a route segment between the pair of location points that follows a path segment of the plurality of paths; combining route segments for each location point pair of the plurality of location point pairs to define a reconstructed route that begins with a first location route pair based on the initial location point and ends with a second location route pair based on the final location point; generating a graphical representation of the reconstructed route; and providing the graphical representation of the reconstructed route for presentation at the user device.

Example 2 can include the computer-implemented method of example 1, wherein the user device comprises a wearable user device, and wherein accessing the location data, accessing the map data, determining the route segment, combining the route segment, generating the graphical representation, and providing the graphical representation are performed by the wearable user device.

Example 3 can include the computer-implemented method of example 1 or 2, wherein accessing the location data, accessing the map data, determining the route segment, and combining the route segment define a route reconstruction operation.

Example 4 can include the computer-implemented method of example 3, wherein the route reconstruction operation is performed in response to at least one of detecting a conclusion of the workout or collecting the final location point.

Example 5 can include the computer-implemented method of example 3, wherein the route reconstruction operation is performed in substantially real-time with at least one of detecting a conclusion of the workout or collecting the final location point.

Example 6 can include the computer-implemented method of any of examples 1-5, further comprising collecting the location data during the workout, and wherein accessing the location data, accessing the map data, determining the route segment, combining the route segment, generating the graphical representation, and providing the graphical representation are performed after conclusion of the workout.

Example 7 can include the computer-implemented method of any of examples 1-6, wherein determining a route segment for the plurality of location point pairs comprises determining whether a shortest route segment that connects the respective pair of location points can be found.

Example 8 can include the computer-implemented method of example 7, wherein, in the event that the shortest route segment along at least one of the plurality of paths cannot be found, the computer-implemented method further comprises: accessing pedometer data associated with a time between when the pair of location points were collected; and using the pedometer data to generate a potential path segment between the pair of location points, wherein the potential path segment avoids any of the plurality of paths.

Example 9 can include the computer-implemented method of example 8, wherein generating the graphical representation of the reconstructed route comprises using a first graphical representation for the route segments and a second graphical representation for the potential path segment.

Example 10 can include the computer-implemented method of any of examples 1-9, further comprising: downloading the map data from a service provider; and caching the map data in memory of the user device.

Example 11 can include the computer-implemented method of example 10, wherein the map data corresponds to a geographic region, and wherein the geographic region is determined by user device data relating to geographic location.

Example 12 can include the computer-implemented method of any of examples 1-11, further comprising determining to use the sparse location data collection mode based on contextual data.

Example 13 can include the computer-implemented method of any of examples 1-12, further comprising determining to use the sparse data collection mode based a user input that selects the sparse data collection mode from among the plurality of location data collection modes.

Example 14 can include the computer-implemented method of any of examples 1-13, wherein, when in the sparse data collection mode, the user device is configured to collect each location point at a first frequency of about every two minutes, and wherein the reconstructed route approximates collection of each location point at a second frequency of about every one second.

Example 15 can include the computer-implemented method of any of examples 1-14, wherein the sparse data collection mode is configured to collect sparse location data as compared to a typical data collection mode.

Example 16 can include the computer-implemented method of any of examples 1-15, wherein determining the route segment comprises using a graph traversal search technique.

Example 17 can include the computer-implemented method of any of examples 1-16, wherein the initial route is unassociated with any paths of the plurality of paths, and wherein the reconstructed route is associated with at least one path of the plurality of paths.

Example 18 can include the computer-implemented method of any of examples 1-17, further comprising generating a route distance based on the reconstructed route, and wherein the graphical representation of the reconstructed route comprises the route distance.

Example 19 can include the computer-implemented method of example 18, wherein the route distance is a reconstructed route distance, wherein the initial route is associated with an initial route distance.

Example 20 can include the computer-implemented method of example 19, wherein the reconstructed route distance is greater than the initial route distance.

Example 21 can include the computer-implemented method of example 19, wherein the reconstructed route distance is more accurate than the initial route distance with respect to an actual route the user device moved during the workout.

Example 22 can include the computer-implemented method of any of examples 1-21, wherein each location point of the plurality of location points is determined by at least: turning on a location measurement device; collecting a plurality of location measurements while the location measurement device is turned on; evaluating the plurality of location measurements with respect to a set of selection criteria; picking a particular location measurement of the plurality of location measurements as the location point based on evaluating the plurality of location measurements with respect to the set of selection criteria.

Example 23 can include the computer-implemented method of any of examples 1-22, further comprising accessing user behavior data associated with a behavior of a user of the user device, and wherein determining each route segment is based at least in part on the user behavior data.

Example 24 can include the computer-implemented method of any of examples 1-23, further comprising: receiving a first user input to begin the workout; and receiving a second user input to conclude the workout.

Example 25 can include the computer-implemented method of any of examples 1-24, wherein the graphical representation of the reconstructed route comprises a line that represents the reconstructed route, and wherein providing the graphical representation comprises providing the graphical representation overlaid on a map view.

Example 26 can include the computer-implemented method of any of examples 1-25, wherein determining the route segment between the pair of location points that follows the path segment of the plurality of paths comprises map matching the plurality of location point pairs to path segments of the plurality of path segments.

Example 27 can include a computing device including memory having instructions and processing circuitry coupled with the memory to execute the instructions to perform any of the steps of examples 1-25.

Example 28 can include one or more non-transitory, computer-readable media, wherein the instructions, when executed, further cause an apparatus to perform any of the steps of examples 1-25.

Example 29 can include a computer-implemented method, comprising: collecting, by a user device and prior to a workout, first location data representing a first portion of a route within a geographic region; collecting, by the user device and prior to the workout, odometry data comprising speed and direction information collected along the first at least one portion of the route; accessing map data comprising a plurality of path segments within the geographic region; generating a reconstructed route corresponding to the route by at least: determining route segments based at least in part on first location data and the odometry data; determining updated route segments based at least in part on the map data; and aligning at least one updated route segment of the updated route segments with a path segment of the plurality of path segments, wherein the reconstructed route comprises the at least one updated route segment; generating control instructions for a graphical representation of the reconstructed route; and providing the control instructions for the graphical representation of the reconstructed route for presentation at the user device.

Example 30 can include a computer-implemented method of example 29, wherein the method further comprises: aligning the first location data to a coordinate system of the map data; and aligning the odometry data to the coordinate system of the map data, wherein the reconstructed route is determined based at least in part on the coordinate system of the map data.

Example 31 can include a computer-implemented method of example 29 or 30, wherein the method further comprises: identifying a rectangular corner of the reconstructed route; and smoothing the rectangular corner to convert the rectangular corner to a rounded corner, wherein the control instructions comprises control instructions for displaying the rounded corner.

Example 32 can include a computer-implemented method of any of examples 29-31, wherein route reconstruction is performed in response to detecting a conclusion of the workout.

Example 33 can include a computer-implemented method of any of examples 29-32, wherein the method further comprises: identifying a first set of candidate route segments associated with the first location data; identifying a second set of candidate route segments associated with the first location data; comparing a first length of the first set of candidate route segments to a second length of the second set of candidate route segments; and determining whether to use the first set of candidate route segments or the second set of candidate route segments as the route segments based at least in part on comparing a first length of the first set of candidate route segments to a second length of the second set of candidate route segments.

Example 34 can include a computer-implemented method of any of examples 29-33, wherein collecting the first location data comprises collecting the first location data in response to determining that the odometry data is indicative of a beginning of a physical activity.

Example 35 can include a computer-implemented method of any of examples 29-34, further comprising collecting, by the user device and during the workout, second location data representing a second portion of the route.

Example 36 can include a computer-implemented method of example 35, wherein generating the reconstructed route is further based at least in part on the second location data.

Example 37 can include a computer-implemented method of example 35, wherein collecting the first location data comprises collecting the first location data according to a first data collection frequency of a first operating mode, and wherein collecting the second location data comprises collecting the second location data according to a second data collection frequency of the first operating mode.

Example 38 can include a computer-implemented method of example 37, wherein the second data collection frequency is greater than the first data collection frequency.

Example 39 can include a computing device including memory having instructions and processing circuitry coupled with the memory to execute the instructions to perform any of the steps of examples 29-39.

Example 40 can include one or more non-transitory, computer-readable media, wherein the instructions, when executed, further cause an apparatus to perform any of the steps of examples 29-39.

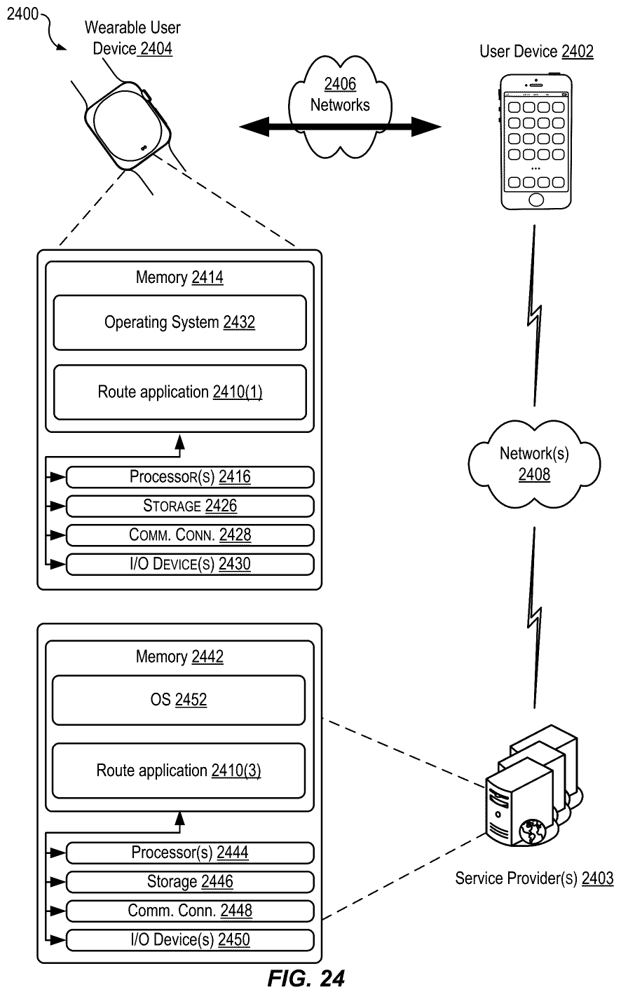

Illustrative methods and systems for reconstructed routes using sparse location data are described above. Some or all of these systems and methods may, but need not, be implemented at least partially by architectures such as those shown at least in FIGS. 1-25. While many of the examples are described above with reference to personal, activity, and/or health-related information, it should be understood that any type of user information or non-user information (e.g., data of any type) may be managed using these techniques. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various examples further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The present disclosure contemplates that in some instances, gathered data described herein may include personally identifiable information (PII) data that uniquely identifies or can be used to contact or locate a specific person. Such personal information data can include demographic data, location-based data, telephone numbers, email addresses, Twitter IDs, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide a family member or friend a view of health data updates. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1. A computer-implemented method, comprising:
accessing location data comprising a set of location points collected by a user device during a workout and defining an initial route, the set of location points comprising an initial location point and a final location point, wherein the user device collects the location data during the workout using a sparse location data collection mode of a plurality of location data collection modes;
accessing map data comprising a plurality of paths within a geographic region;
for a plurality of location point pairs of the set of location points, determining a route segment between the pair of location points that follows a path segment of the plurality of paths;
combining route segments for each location point pair of the plurality of location point pairs to define a reconstructed route that begins with a first location route pair based on the initial location point and ends with a second location route pair based on the final location point;
generating a graphical representation of the reconstructed route; and
providing the graphical representation of the reconstructed route for presentation at the user device.

2. (canceled)

3. The computer-implemented method of claim 1, wherein accessing the location data, accessing the map data, determining the route segment, and combining the route segment define a route reconstruction operation.

4. The computer-implemented method of claim 3, wherein the route reconstruction operation is performed in response to at least one of detecting a conclusion of the workout or collecting the final location point.

5. (canceled)

6. The computer-implemented method of claim 1, further comprising collecting the location data during the workout, and wherein accessing the location data, accessing the map data, determining the route segment, combining the route segment, generating the graphical representation, and providing the graphical representation are performed after conclusion of the workout.

7. The computer-implemented method of claim 1, wherein
determining a route segment for the plurality of location point pairs comprises determining whether a shortest route segment that connects the respective pair of location points can be found.

8. The computer-implemented method of claim 7, wherein, in the event that the shortest route segment along at least one of the plurality of paths cannot be found, the computer-implemented method further comprises:
accessing pedometer data associated with a time between when the pair of location points were collected; and
using the pedometer data to generate a potential path segment between the pair of location points, wherein the potential path segment avoids any of the plurality of paths.

9. (canceled)

10. (canceled)

11. (canceled)

12. The computer-implemented method of claim 1, further comprising determining to use the sparse location data collection mode based on contextual data.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

31. (canceled)

32. (canceled)

33. (canceled)

34. A computing system, comprising:
one or more processors; and
one or more computer-readable media having stored thereon a sequence of instructions that, when executed, cause the one or more processors to:
access location data comprising a set of location points collected by a user device during a workout and defining an initial route, the set of location points comprising an initial location point and a final location point, wherein the user device collects the location data during the workout using a sparse location data collection mode of a plurality of location data collection modes;
access map data comprising a plurality of paths within a geographic region;
for a plurality of location point pairs of the set of location points, determining a route segment between the pair of location points that follows a path segment of the plurality of paths;
combine route segments for each location point pair of the plurality of location point pairs to define a reconstructed route that begins with a first location route pair based on the initial location point and ends with a second location route pair based on the final location point;
generate a graphical representation of the reconstructed route; and
provide the graphical representation of the reconstructed route for presentation at the user device.

35. The computing system of claim 34, wherein accessing the location data, accessing the map data, determining the route segment, and combining the route segment define a route reconstruction operation.

36. The computing system of claim 35, wherein the route reconstruction operation is performed in response to at least one of detecting a conclusion of the workout or collecting the final location point.

37. The computing system of claim 34, wherein the sequence of instructions that, when executed, further cause the one or more processors to:
collect the location data during the workout, and wherein accessing the location data, accessing the map data, determining the route segment, combining the route segment, generating the graphical representation, and providing the graphical representation are performed after conclusion of the workout.

38. The computing system of claim 34, wherein determining a route segment for the plurality of location point pairs comprises determining whether a shortest route segment that connects the respective pair of location points can be found.

39. The computing system of claim 38, wherein, in the event that the shortest route segment along at least one of the plurality of paths cannot be found, and wherein the sequence of instructions that, when executed, further cause the one or more processors to:
access pedometer data associated with a time between when the pair of location points were collected; and
use the pedometer data to generate a potential path segment between the pair of location points, wherein the potential path segment avoids any of the plurality of paths.

40. The computing system of claim 34, wherein the sequence of instructions that, when executed, further cause the one or more processors to:
determine to use the sparse location data collection mode based on contextual data.

41. One or more non-transitory computer-readable media having stored thereon a sequence of instructions that, when executed by one or more processors of a computing system, cause the computing system to:
access location data comprising a set of location points collected by a user device during a workout and defining an initial route, the set of location points comprising an initial location point and a final location point, wherein the user device collects the location data during the workout using a sparse location data collection mode of a plurality of location data collection modes;
access map data comprising a plurality of paths within a geographic region;
for a plurality of location point pairs of the set of location points, determining a route segment between the pair of location points that follows a path segment of the plurality of paths;
combine route segments for each location point pair of the plurality of location point pairs to define a reconstructed route that begins with a first location route pair based on the initial location point and ends with a second location route pair based on the final location point;
generate a graphical representation of the reconstructed route; and
provide the graphical representation of the reconstructed route for presentation at the user device.

42. The one or more non-transitory computer-readable media of claim 41, wherein accessing the location data, accessing the map data, determining the route segment, and combining the route segment define a route reconstruction operation.

43. The one or more non-transitory computer-readable media of claim 42, wherein the route reconstruction operation is performed in response to at least one of detecting a conclusion of the workout or collecting the final location point.

44. The one or more non-transitory computer-readable media of claim 41, wherein the sequence of instructions that, when executed, further cause the one or more processors to:
collect the location data during the workout, and wherein accessing the location data, accessing the map data, determining the route segment, combining the route segment, generating the graphical representation, and providing the graphical representation are performed after conclusion of the workout.

45. The one or more non-transitory computer-readable media of claim 41, wherein determining a route segment for the plurality of location point pairs comprises determining whether a shortest route segment that connects the respective pair of location points can be found.

46. The one or more non-transitory computer-readable media of claim 45, wherein, in the event that the shortest route segment along at least one of the plurality of paths cannot be found, and wherein the sequence of instructions that, when executed, further cause the one or more processors to:
access pedometer data associated with a time between when the pair of location points were collected; and
use the pedometer data to generate a potential path segment between the pair of location points, wherein the potential path segment avoids any of the plurality of paths.

47. The one or more non-transitory computer-readable media of claim 41, wherein the sequence of instructions that, when executed, further cause the one or more processors to:
determine to use the sparse location data collection mode based on contextual data.
